(19) United States
(12) Patent Application Publication
(10) Pub. No.: US 2024/0108003 A1
(43) Pub. Date: Apr. 4, 2024

(54) COMPOSITIONS AND METHODS FOR IMPROVING PLANT PERFORMANCE

(71) Applicant: Advanced Crop Chemistry, Santa Fe, NM (US)

(72) Inventors: Pat J. Unkefer, Los Alamos, NM (US); Nigel Grech, Fresno, CA (US)

(21) Appl. No.: 18/375,942

(22) Filed: Oct. 2, 2023

Related U.S. Application Data
(60) Provisional application No. 63/411,636, filed on Sep. 30, 2022.

(51) Int. Cl. A01N 43/36; A01N 25/04; A01P 21/00

(52) U.S. Cl. CPC A01N 43/36; A01N 25/04; A01P 21/00

(57) ABSTRACT

Compositions and methods that increase plant performance in terms of nitrogen uptake, photosynthesis, growth, yield, tolerance to biotic and abiotic stressors, disease resistance, and general plant health are disclosed. The compositions of the present invention may include 2-hydroxy-5-oxoproline or derivatives thereof, L-pyroglutamic acid or derivatives thereof, and combinations thereof are of particular use in agricultural applications and can be applied to a plant, a seed, the soil, or combinations thereof. The methods of the present invention have broad applications in agriculture for crop management, reduction of food pollution, reduction of crop carbon footprints, and the general improvement of food quality and safety.

### FIELD OF THE INVENTION

This invention relates to the compositions, and methods that increase plant performance examples of which include, nitrogen uptake, photosynthesis, growth, yield, tolerance to biotic and abiotic stressors, disease resistance, and general plant health. These compositions and methods have broad applications in agriculture for crop management, reduction of food pollution, reduction of crop carbon footprints, and the general improvement of food quality and safety.

### BACKGROUND OF THE INVENTION

Farming is under increasing pressure to produce more while reducing the amount of nitrogen leaching into surface waters. This requires changing farming practices and the development of technologies that increase crops' uptake of nitrogen. This increased nitrogen taken into the plants drives increased photosynthesis and uptake of the other required nutrients. These changes increase growth and ultimately yield.

Commercial crop systems increasingly encompass integrated pest & disease management (IPM) strategies to reduce excessive use of environmentally harmful chemicals and to increase the efficacy of the crop management programs. Additionally, biotic stresses (such as temperature, root zone hypoxia, salinity, nutrient supply disruption, photo-oxidative stresses, and herbicide stress) can be detrimental to crop productivity. Typically, prophylactic stress management strategies are more successful than curative ones in crop management. This approach requires plant priming prior to a stress event to minimize the interval between the negative effect of the stressors on the plant and the concomitant response of the plant to the specific stressors. How plants tolerate and manage these stressors is complex and multifaceted. Water and nutritional management play key roles in metabolic regulatory events that contribute to how plants respond to stress. A key anchor pathway in these processes is GOGAT/GS, which contributes anabolically to many defensive and stress-management compounds and precursors.

Plants have highly conserved strategies to cope with diseases through several mechanisms such as exclusion, compartmentalization, and the synthesis of antimicrobials. These strategies are energetically costly and therefore usually are only induced once a pathogen is detected. Hence early detection and upregulation of disease management systems are critical as a survival strategy. Hence innate and adaptive tolerance is a key survival component of all plants. Many plant diseases also involve toxin-producing microbes which can have drastic consequences in commercial crop plants even at low disease incidence levels. It is well known that microbial toxins are produced by certain fungi and bacteria species. In nature, these microorganisms produce elevated levels of toxins under various environmental conditions as a response to stress, such as competition from other microorganisms or the presence of metabolic toxicants such as agricultural fungicides and bacteriacides. Among these toxins, the mycotoxins produced by fungi cause an estimated $10 billion in losses annually across the globe. Microbial toxins include compounds that are acutely toxic, carcinogenic, immunosuppressive, or estrogenic; they have been the cause of serious human and/or animal diseases. “Mycotoxins” are toxic molecules produced by fungal species, such as polyketides (including aflatoxins, demethylsterigmatocystin, O-methylsterigmatocystin, etc.), fumonisins, alperisins, sphingofungins (A, B, C and D), trichothecenes, and fumifungins. Polyketides are a large structurally diverse class of secondary metabolites synthesized by bacteria, fungi, and plants and are formed by polyketide synthase (PKS) through the sequential condensation of small carboxylic acids. Bacterial phytotoxins primarily impact plants with little carry over into the human food chain. Pseudomonads are significant producers of phytotoxins. For example, Pseudomonas syringae pv. phaseolica produces phaseolotoxin, which inhibits ornithine carbamoyl transferase, blocking arginine biosynthesis.

Infectious organisms in plants can be controlled through the use of agents that are selectively biocidal for the pathogens. Another method is interference with the mechanism by which the pathogen invades the host crop plant. Yet another method, in the case of pathogens that cause crop losses, is interference with the mechanism by which the pathogen causes injury to the host crop plant. Still another method, in the case of pathogens that produce toxins that are undesirable to mammals or other animals that feed on the crop plants, is interference with toxin production, storage, or activity.

Other crop pests include insects and root parasites. Insect herbivory in many instances is exacerbated on plants exhibiting certain physiological stresses; indeed, it is well known that insects such as thrips, white flies, and aphids are preferentially attracted to plants that are undergoing one or more stresses. Nematodes are root parasites that damage plant root systems and impair the plant's ability to take up water and nutrients.

Climate change presents an ancillary, but important issue to the agricultural industry. Improved crop yields may be a useful means of carbon sequestration. It is estimated that US farmland could sequester 5,000 MMT of soil organic carbon over a 50-year period. Kern, J S 1994 Spatial patterns of soil organic carbon in the contiguous United States. Soil Sci. Soc. Am. J. 58: 439-455. The source of this carbon would be increased crop residues left in the field. Examples of technologies that would increase the crop residues left in the field are those that increase above-ground biomass and below-ground biomass. For plants to produce greater biomass they must have increased nitrogen uptake and greater photosynthesis. The greater nitrogen taken up must be efficiently utilized as evidenced by leaf protein content and grain and tuber yields. The greater photosynthesis can be measured directly and will also be evidenced by greater biomass. Crop and soil management practices continue to be improved. As the need to remove carbon from the atmosphere becomes increasingly more urgent, programs and processes to pay farmers for sequestering carbon in the soil are emerging. Wesseler, S 2020 Startups aim to pay farmers to bury carbon pollution in soil. Yale Climate Connections Newsletter. January 30. Such programs are expected to accelerate the need for technologies to support increased sequestration of carbon in agricultural soils. Fortunately, land plants have excess capacity to sequester atmospheric carbon as they evolved in an atmosphere with several times the current CO₂. As such, if their CO₂ fixation metabolism could be upregulated cost-effectively, crop plants could sequester greater amounts of CO₂, consequently further reducing atmospheric greenhouse gases.

### BRIEF SUMMARY OF THE INVENTION

It has been found that 2-hydroxy-5-oxoproline (2HOP) and L-pyroglutamate (L-PGA) have significant utility in agricultural applications. Applicant(s) have conceived novel 2-hydroxy-5-oxoproline (2HOP) and L-PGA compositions and applications in plants to improve plant performance.

The compositions containing 2-hydroxy-5-oxoproline or derivatives thereof (e.g., salts), L-pyroglutamic acid or derivatives thereof (e.g., salts), and combinations thereof are of particular use in agricultural applications and can be applied to a plant, a seed, the soil or combinations thereof. When applied, the compositions improve the plant's nitrogen uptake, nutrient use efficiency, resistance to abiotic stress, resistance to biotic stress, disease resistance, and total photosynthesis which combine to improve the plant's overall agronomic performance (yield and quality).

The compositions of the invention are provided in concentrated form or in use dilution, a concentrate, a suspension, a solid form, and liquid solutions. When diluted for use, the compositions of the invention are substantially fully solubilized in the dilution medium. The compositions of the invention suppress plant stresses such as disease, abiotic stress, and inhibition of formation of associated microbial toxins.

The composition, when applied to the plant, elevates key pathways and indicator molecules of disease defenses in plants, such as the shikimic acid pathway and aromatic acids that are predictive of innate and adaptive tolerance to biotic and abiotic stress such as disease, cold, salinity, etc. In exemplary embodiments, the level of innate and adaptive tolerance to stress is clearly elevated.

The compositions of the invention are capable of not only suppressing disease, but also significantly diminishing the effects of microbial toxins. Toxins can be present in plant tissue. The invention suppresses the level of microbial toxins in plant tissue. In preferred embodiments, the application of the invention to plants and/or their growth media suppresses mycotoxin biosynthesis.

The invention provides a method for increasing nitrogen uptake and nitrogen use efficiency as evidenced by greater leaf protein, greater grain yield and greater nitrogen in above-ground biomass. The invention provides a method for increasing the uptake use efficiency of other nutrients, such as potassium, phosphorous, and sulfur as evidenced by greater leaf protein, greater grain yield and greater nutrient levels in above-ground biomass. The invention provides a method for increased carbon captured by increasing photosynthesis and greater above-ground biomass and below-ground mass.

Other aspects, objects, and advantages of the invention are apparent from the detailed description that follows.

### BRIEF DESCRIPTION OF THE DRAWINGS

FIG. 1: The line structures for 2HOP and L-PGA are provided in FIG. 1.

FIG. 2A: Treatments with compositions comprising 2HOP, L-PGA, and 2HOP+L-PGA alone or in combination with fungicides for the suppression of Diseases of Cereals.

FIG. 2B: Results of treatments with compositions comprising 2HOP, L-PGA, and 2HOP+L-PGA alone or in combination with fungicides for the suppression of Diseases of Cereals.

FIG. 3A: The effect of 2HOP or L-PGA or the combination of them on growth of a fungal plant pathogen was examined through colony diameter.

FIG. 3B: The effect of 2HOP or L-PGA through foliar treatment of lettuce plants with L-PGA (0.5 g/L) or 2HOP (0.5 g/L) was examined.

FIG. 4: Suppression of mycotoxin expression in wheat plants infected with Fusarium graminearum Schwabe Group 2, the causal fungus of Fusarium Head Blight (FHB).

FIG. 5A: The effects of L-PGA alone or in combination with a nematicide on yield from grapevines grown in nematode infested soil, and on the nematode populations.

FIG. 5B: The effects of L-PGA alone or in combination with a nematicide on root knot nematode populations from grapevines grown in nematode infested soil.

FIG. 5C: The effects of L-PGA alone or in combination with a nematicide on nematode populations from grapevines grown in nematode infested soil.

FIG. 6A: The effect of a foliar application of various herbicides sprayed with and without 2HOP or L-PGA on foliar biomass of greenhouse wheat, assessed 10 days after application.

FIG. 6B: The effects of various herbicide treatments on wheat, one day post application.

FIG. 6C: The effect of 2HOP and L-PGA when tank mixed with various herbicides and sprayed onto wheat, 10 days after application.

FIG. 7A: The effects of 2HOP or L-PGA on cold tolerance in a cold sensitive plant.

FIG. 7B: The effects of 2HOP or L-PGA on cold tolerance in a cold sensitive plant.

FIG. 8: Early emergence of tillers on wheat seedlings treated with different combinations of 2HOP+L-PGA.

FIG. 9: Effects of the combination of 2-hydroxy-5-oxoproline and L-pyroglutamate on below-ground biomass, an indicator of plant growth and carbon sequestration.

FIG. 10: Effects of 2-hydroxy-5-oxoproline on the growth and carbon sequestration factors of dry weight and carbon fixation capability in lettuce.

FIG. 11: Effects of soil application of 2-hydroxy-5-oxoproline or L-Pyroglutamate on the carbon fixation capability in greenhouse grown oats.

FIG. 12A: Effects of 2HOP, L-PGA, and 2HOP+L-PGA on leaf tissue nutrient levels in plant leaves of greenhouse-grown tomato.

FIG. 12B: Effects of 2HOP, L-PGA, and 2HOP+L-PGA on nutrient stoichiometry in plant leaves of greenhouse-grown tomato.

FIG. 12C: Effects of 2HOP, L-PGA, and 2HOP+L-PGA on total nutrient taken up and incorporated into plant leaves of greenhouse-grown tomato.

FIG. 13: Treatment effects of 2HOP, L-PGA and 2HOP+L-PGA on greenhouse pepper and tomato plants.

FIG. 14: Effects of seed treatments of L-PGA, 2HOP and 2HOP+L-PGA on greenhouse grown wheat leaf emergence.

FIG. 15: Yield and emergence impacts of L-PGA, 2HOP, and 2HOP+L-PGA treatments on field grown wheat.

FIG. 16: L-PGA, 2HOP, and 2HOP+L-PGA foliar treatment effects on field wheat yield.

FIG. 17: Effects of the combination of 2-hydroxy-5-oxoproline and L-pyroglutamate on above-ground wheat biomass.

FIG. 18: Effects of 2-hydroxy-5-oxoproline and L-pyroglutamate on the carbon sequestration factors, green area index, canopy cover in field grown wheat.

FIG. 19: Effects of the combination of 2-hydroxy-5-oxoproline and L-pyroglutamic acid on potato.

FIG. 20A: The effect of two different irrigation regimes and L-PGA/2HOP chemigation treatments on field corn productivity.

FIG. 20B: Dosage response of L-PGA:2HOP on wheat fertilized with UAN 32.

### DETAILED DESCRIPTION OF THE INVENTION

References will now be made in detail to certain embodiments of the invention, and example compositions, and applications of such embodiments. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

### Compositions

The present invention relates to compositions for improving the growth, yield, abiotic stress resistance, biotic stress resistance, disease resistance, parasite resistance, and general health of plants. The compositions may include effective amounts of 2HOP and derivatives thereof (e.g., salts thereof, including a sodium salt thereof, a potassium salt thereof, including a ammonium salt thereof, and/or calcium salt thereof), L-PGA and derivatives thereof (e.g., salts thereof, including a sodium salt thereof, a potassium salt thereof, including a ammonium salt thereof, and/or a calcium salt thereof), and combinations thereof with other compounds and materials to form solutions (concentrates, dilutions, etc.), suspensions, and solids for application to plants and/or growth media therefor.

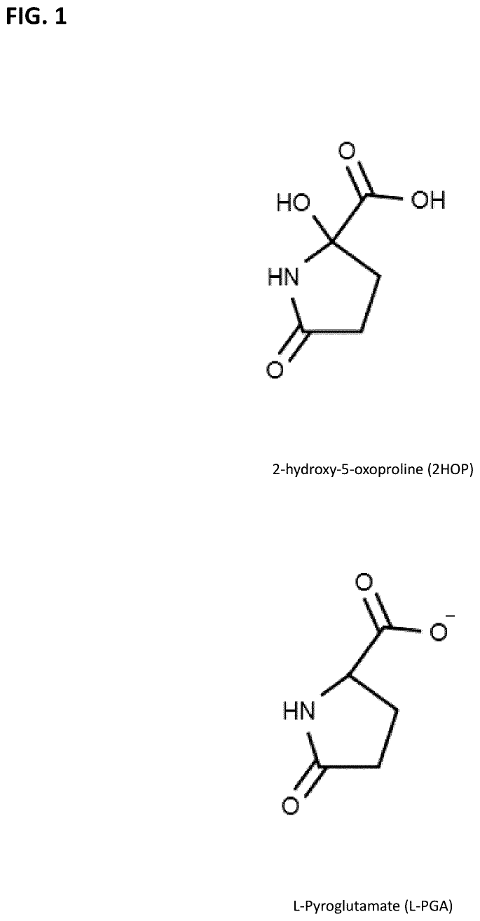

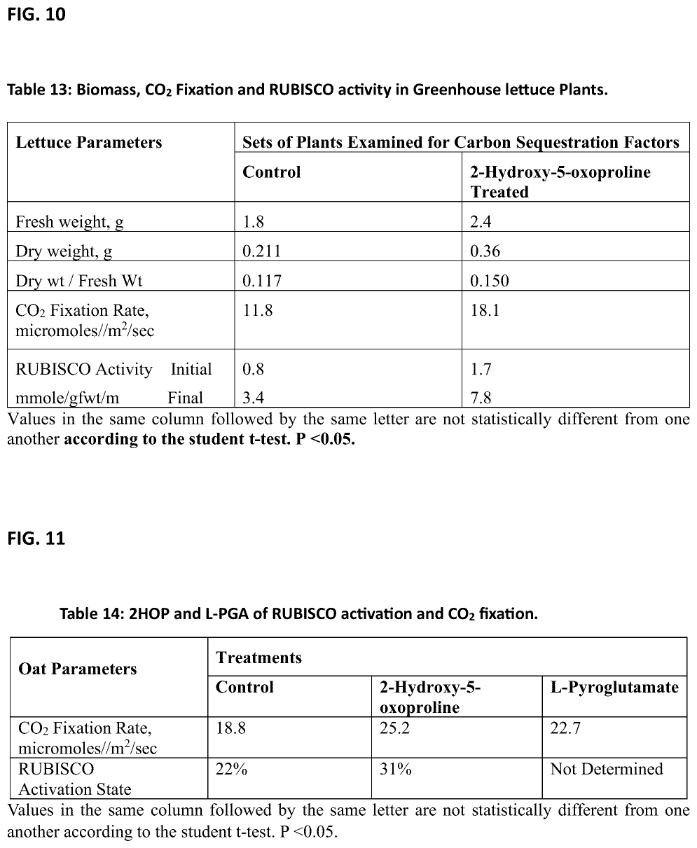

Extensive testing has demonstrated the superior performance of using 2HOP alone and in combination with L-PGA are effective for increased metabolism and overall performance of crop plants. The combination of 2HOP and L-PGA has exhibited synergistic effects on plant growth and yield (see, e.g., FIGS. 13-16 and 19). A structural difference between these two compounds accounts in large part for the performance enhancement resulting from their mixture. 2HOP has a specific hydroxyl group that allows clearer recognition and stronger binding by its target protein than does L-pyroglutamate, which lacks this hydroxyl group. The line structures for the compounds are provided in FIG. 1. 2HOP is the actual metabolite whereas L-PGA is a partial mimic or an imposter metabolite. Because biological activity requires that molecules be recognized and bound by a specific target protein, this hydroxyl group allows 2HOP to stay bound to the target protein longer and enhance plant performance. The combination of 2HOP with L-PGA is carefully constructed to maximize a plant's response and synergistically enhance the health and performance of the treated plant.

The formulations of the present invention may be advantageously applied to plants by several means, including, but not limited to, spraying, irrigating, fertigating, coating, emersion, injecting, seed treatment, or any combination thereof. In some embodiments, the compositions of the invention can also be applied directly to the plant or part of the plant, e.g., leaf, root, foliage, tiller, flower, or a combination thereof. The compositions of the present invention are also effective to affect metabolism of a plant cells and plant tissue when applied directly thereto. The compositions of the invention can be applied to seeds (e.g., as a coating or by treatment of the seed by spraying or immersion, etc.), and/or applied pre-emergent (before the seedlings emerge or appear above ground). The compositions of the invention can be applied to a propagation material of the plant. For example, the compositions of the invention can be applied to a propagation material, such as a seed, a grain, a fruit, a tuber, a spore, a cutting, a slip, a meristem tissue, a plant cell, a nut, or an embryo. The compositions of the invention can also be applied to the growth medium (e.g., by applying to the soil around the plants).

In some implementations, the amount of 2HOP applied to a hectare to treat plants present therein may be in a range of about 1 g (0.0069 moles) to about 500 g (3.45 moles): e.g., in a range of about 50 g (0.345 moles) to about 250 g (1.72 moles), in a range of about 100 g (0.670 moles) to about 200 g (1.38 moles), or any value or range of values therein. The 2HOP or derivative thereof may be diluted in a spray application solution having a volume of about 100 L to about 500 L (e.g., a volume of about 150 L to about 350 L, a volume of about 200 L to about 300 L, or any value or range of values therein). In some embodiments, the amount of 2HOP or functional derivative thereof present in the formulation is between about 0.02 g/L (about 0.138 mM, about 0.002% wt/v) to about 5 g/L (about 34 mM, about 0.5% wt/v), e.g., about 0.1 g/L (about 0.689 mM, about 0.01% wt/v) to about 1 g/L (about 6.70 mM, about 0.1% wt/v); about 0.2 g/L (about 1.38 mM, about 0.02% wt/v) to about 2 g/L (about 13.8 mM, about 0.2% wt/v), or any value or range of values therein. The solubility of 2HOP in aqueous solutions is about 145 g/L to about 435 g/L (1-3 molar), and thus more concentrated formulations for applications other than field spraying are contemplated in the present application. In some embodiments, the composition may be a dry fertilizer formulation that includes 2HOP or functional derivative thereof in an amount of about 1 g/Kg to about 100 g/Kg (about 0.1 wt % to about 10 wt %), e.g., about 5 g/Kg to about 50 g/Kg of the formulation (about 0.5 wt % to about 5 wt %), about 10 g/Kg to about 30 g/Kg of the formulation (about 1 wt % to about 3 wt %).

In some implementations, the amount of L-PGA applied to a hectare to treat plants present therein may be in a range of about 10 g (0.069 moles) to about 500 g (3.45 moles): e.g., in a range of about 50 g (0.345 moles) to about 250 g (1.72 moles), in a range of about 100 g (0.670 moles) to about 200 g (1.38 moles), or any value or range of values therein. The L-PGA may be diluted in a spray application solution having a volume of about 100 L to about 500 L (e.g., a volume of about 150 L to about 350 L, a volume of about 200 L to about 300 L, or any value or range of values therein). In some embodiments, the amount of L-PGA or functional derivative thereof present in the formulation is between about 0.02 g/L (about 0.138 mM, about 0.002% wt/v) to about 5 g/L (about 34 mM, about 0.5% wt/v), e.g., about 0.1 g/L (about 0.689 mM, about 0.01% wt/v) to about 1 g/L (about 6.70 mM, about 0.1% wt/v); about 0.2 g/L (about 1.38 mM, about 0.02% wt/v) to about 2 g/L (about 13.8 mM, about 0.2% wt/v), or any value or range of values therein. The solubility of L-PGA in aqueous solutions is about 145 g/L to about 435 g/L (1-3 molar), and thus more concentrated formulations for applications other than field spraying are contemplated in the present application. In some embodiments, the composition may be a dry fertilizer formulation that includes L-PGA or functional derivative thereof in an amount of about 1 g/Kg to about 100 g/Kg (about 0.1 wt % to about 10 wt %), e.g., about 5 g/Kg to about 50 g/Kg of the formulation (about 0.5 wt % to about 5 wt %), about 10 g/Kg to about 30 g/Kg of the formulation (about 1 wt % to about 3 wt %).

In some implementations, the compositions of the present technology may include liquid seed treatments, seed coatings, and other seed treatment formulations. The coating composition may include an aqueous seed treatment solution with about 0.1% wt/v to about 5.0% wt/v of 2HOP or derivative thereof, L-PGA or functional derivative thereof, and combinations thereof. The seed coating compositions may further include binders, such as film coating materials (e.g., polyvinyl alcohol, soy flour, Arabic gum, sugars, starches, and other materials), and encrusting materials (e.g., biochar, gypsum, montmorillonite, bentonite, and other materials); biocides as described herein; growth regulators, such as compounds and/or microbes stimulating growth; preservatives; stabilizers; nutrient salts (e.g., N, P, K, and other micro and micro nutrient salts), and/or other constituents. For coating seeds, the amount of binding agent compound may be about 0.01% wt/v, to about 10% wt/v. The seed coating composition may be applied to seeds such that 2HOP or derivative thereof, L-PGA or functional derivative thereof, and combinations thereof are applied such that about 1 g (0.0069 moles) to about 500 g (3.45 moles) is applied a hectare to treat the seeds planted therein: e.g., in a range of about 10 g (0.345 moles) to about 250 g (1.72 moles), in a range of about 50 g (0.670 moles) to about 200 g (1.38 moles), or any value or range of values therein.

Ratios of 2HOP to L-PGA in various compositions may be in a range of about 1:1 to about 1:10 (e.g., in a range of about 1:3 to about 1:7, in a range of about 1:5 to about 1:7) in various applications, such as foliar spray, fertigation, in furrow application, dry fertilizer soil application, etc. The formulations of the present invention may also include organic acids, adjuvants, thickeners, humectants, surfactants, plant growth regulators, fertilizers, pesticides, and diluents.

Derivative Compounds

In some embodiments of the present invention, the composition may include functional derivatives of 2HOP and/or L-PGA. The derivative compounds may include inorganic salts of 2HOP and/or L-PGA (e.g., fertilizer salts, common ag salts, organic salts, and esters thereof). The inorganic salts be one or more alkaline metal salts (e.g., sodium, potassium, etc.), alkaline earth metal salts, transition metal salts, or mixtures thereof. In some embodiments of the invention, the 2HOP derivative compound(s) may include salts and complexes of 2HOP with phosphate, nitrate, ammonium, and other polyatomic ions (e.g., those incorporating P, N, K nutrients). In some embodiments of the invention, the L-PGA derivative compound(s) may include salts and complexes of L-PGA with phosphate, nitrate, ammonium, and other polyatomic ions (e.g., those incorporating P, N, K nutrients).

The derivatives of the 2HOP and L-PGA compounds have increased weight due to the presence of ions bonded therewith. The 2HOP and L-PGA derivates may be present in the formulations of the present disclosure in the same molar ratios as discussed above, and weight ratios of the active 2HOP derivative compound and L-PGA derivative compound may be adjusted to account for the difference in molecular weight difference to achieve the same concentrations in the formulation when used in place of 2HOP and L-PGA.

Organic Acids

Organic acids are useful in the invention for several purposes. As used herein, the term “organic acid” refers to organic acids as well as their salts. First, an organic acid can increase the solubility of the nutrient composition of 2HOP or derivatives thereof, L-PGA or derivatives thereof, or combinations thereof in the formulations of the invention.

Organic acids of use in the invention include monocarboxylic acids, dicarboxylic acids, tricarboxylic acids, and higher carboxylic acids, e.g., ethylenediaminetetraacetic acid (EDTA) and hydroxyethylenediaminetriacetic acid (HEDTA). Other organic acids of use in the invention include amino acids (e.g., proline, arginine, tryptophan, aspartic acid, glutamic acid, serine, threonine, and cysteine) and fatty acids (including both saturated acids, e.g., lauric, myristic, stearic, and arachidonic acids, as well as unsaturated acids, e.g., oleic, linoleic, cinnamic, linolenic, and eleostearic).

Carboxylic acids of use in formulations of the invention contain substituted or unsubstituted alkyl, substituted or unsubstituted cycloalkyl, substituted or unsubstituted heteroalkyl, substituted or unsubstituted heterocycloalkyl, substituted or unsubstituted aryl, and substituted or unsubstituted heteroaryl moieties. Exemplary monocarboxylic acids that can be used in the invention include methanoic (formic) acid, ethanoic (acetic) acid, propanoic (propionic) acid, and butanoic (butyric) acid.

Biocides

Biocides are may be used in the formulations of the invention. As used herein, the term “biocide” refers to a chemical substance that is capable of killing or retarding the growth, division or reproduction of a living organism. The biocides used in the invention can be a pesticide, which includes fungicides, herbicides, insecticides, algicides, moluscicides, miticides, and rodenticides, or an antimicrobial, which includes germicides, antibiotics, antibacterials, antivirals, antifungals, antiprotozoals, and antiparasites. The biocide used in the invention is capable of killing or inhibiting the growth of various forms of living organisms such as fungi, bacteria, parasites, and other plant pathogens.

In an exemplary embodiment of the invention, the biocide is a fungicide or a fungistat. Exemplary fungicides and fungistats that can be used in the invention include dithiocarbamates and carbamates, e.g., Mancozeb, Maneb, Propineb, Zineb, Ziram, Metiram, Thiram and propamacarb; anilinopyrimidines, e.g., Cyprodinil, Andoprim, Mepanipyrim and Pyremethanil; phenylpyrroles and guanidines, e.g., Fenpiclonil, Fludioxonil, Dodine, Guazatine and Iminoctadine; inhibitors of sterol synthesis, e.g., triazoles, imidazoles and pyrimidines, e.g., tebuconazole, propiconazole, flusilazole, prothioconazole, metaconazole, terboconazole, epoxyconazole, fluquinconazole, cyproconazole, difenaconazole, Bromuconazole, triadiminol, triadimefon, flutriafol, prochloraz, imazalil, bitertanol, nuarimol, fenarimol, Ethirimol, Bupirimate, and Fenapanil; morpholines and piperidines, e.g., Dodemorph, Tridemorph, Aldimorph, Fenpropimorph, and Fenpropidine; dicarboximides, e.g., Iprodione, Vinclzolin, Procymidone, and Chlozolinate; chloronitriles, e.g., Chlorthalonil; phthalimides, phthalonitriles and phthalimides (e.g., Folpet®, Captafol®, or Captan®); strobilurin-based compounds, e.g., azoxystrobin, trifluroxystrobin, kresoxim-methyl, fluoxastrobin, pyraclostrobin, and dimoxystrobin; benzimidazole-based compounds, e.g., benomyl, carbendazim, fuberidazol, thiabendazole, fuberidazol, and thiophanate-methyl; phenylamides, e.g., acylalanines and related compounds, such as furalaxyl, benalaxyl, oxadixyl, ofurace and metalaxyl; cinnamic acid derivatives, e.g., dimethomorph; phosphonates, e.g., fosetyl-Al®; resistance inducers, e.g., 2,6-dichloroisonicotinic acid, acibenzolar-S-methyl, salicylate, β-aminobutyrate, trigonelline-hydrochlorid and probenazole; melanin biosynthesis inhibitors (MBI's), e.g., phthalide, pyroquilon, tricyclazole; and inorganic compounds, e.g., sulfur, Bordeaux mixture, copper hydroxide, copper oxychloride, mercuric oxide, mercury chloride and tin compounds.

In an exemplary embodiment of the invention, the biocide is an antibacterial agent. In another embodiment of the invention, the biocide is an antibiotic, e.g., streptomycin, agrimycin, Blasticidin, Kasugamycin, Polyoxin, validamycin, and gentamycin.

Adjuvants

Adjuvants are commonly used in agriculture to help improve the performance of agrochemicals. The composition of this invention can be combined with adjuvants to produce a practical tank or product mixture. The composition according to the present invention can further comprise other agronomically suitable excipients, such as other surfactants, solvents, pH modifiers, viscosity modifiers (rheology modifiers), crystallization inhibitors, antifoam agents, dispersing agents, wetting agents, humectants, emulsifiers, anticaking agent, suspending agents, spray droplet modifiers, pigments, antioxidants, UV protectants, compatibilizing agents, sequestering agents, neutralizing agents, corrosion inhibitors, dyes, odorants, spreading agents, penetration aids, lubricants, sticking agents, thickening agents, freezing point depressants, antimicrobial agents, and the like. The composition content of these auxiliary excipients is not particularly limiting and may be determined by a skilled technician in the art according to the conventional protocols.

In an embodiment of the present invention, the surfactants that can be additionally added to the compositions are selected from nonionic and/or anionic surfactants. Examples of nonionic surfactants include alkylphenol alkoxylates, alcohol alkoxylates, fatty amine alkoxylates, polyoxyethylene glycerol fatty acid esters, castor oil alkoxylates, fatty acid alkoxylates, fatty amide alkoxylates, fatty polydiethanolamides, lanolin ethoxylates, fatty acid polyglycol esters, isotridecyl alcohol, fatty amides, methylcellulose, fatty acid esters, alkyl polyglycosides, glycerol fatty acid esters, polyethylene glycol, polypropylene glycol, polyethylene glycol/polypropylene glycol block copolymers, polyethylene glycol alkyl ethers, polypropylene glycol alkyl ethers, polyethylene glycol/polypropylene glycol ether block copolymers, polyethylene oxide/polypropylene oxide block copolymers, and mixtures thereof. Preferred nonionic surfactants are fatty alcohol ethoxylates, alkyl polyglycosides, glycerol fatty acid esters, castor oil alkoxylates, fatty acid alkoxylates, fatty amide alkoxylates, lanolin ethoxylates, fatty acid polyglycol esters and ethylene oxide/propylene oxide block copolymers and mixtures thereof.

Examples of anionic surfactants include alkylaryl sulfonates, phenyl sulfonates, alkyl sulfates, alkyl sulfonates, aryl alkyl sulfonates, alkyl ether sulfates, alkylaryl ether sulfates, alkyl-polyglycol ether phosphates, polyaryl phenyl ether phosphates, alkyl-sulfosuccinates, olefin sulfonates, paraffin sulfonates, petroleum sulfonates, taurides, sarcosides, salts of fatty acids, alkyl-naphthalene sulfonic acids, naphthalene sulfonic acids and ligno sulfonic acids, condensates of sulfonated naphthalenes with formaldehyde or with formaldehyde and phenol and, if appropriate, urea, and also condensates of phenol sulfonic acid, formaldehyde and urea, lignosulfite waste liquors and lignosulfonates, alkyl phosphates, alkylaryl phosphates, for example tristyryl phosphates, and also polycarboxylates, such as, for example, polyacrylates, maleican hydride/olefin copolymers, including the alkali metal, alkaline earth metal, ammonium and amine salts of the substances mentioned above and mixtures thereof. Preferred anionic surfactants are those which carry at least one sulfonate group, and in particular their alkali metal and their ammonium salts and mixtures thereof. In another embodiment, the surfactants can be selected from a blend of alkyl benzene sulfonate and polyoxyalkylene copolymers.

In an embodiment of the present invention, the composition can comprise pH modifiers. Suitable pH modifiers comprise buffers. Examples of buffers are alkali metal salts of weak inorganic or organic acids, such as, for example, phosphoric acid, phosphorous acid, boric acid, acetic acid, propionic acid, citric acid, fumaric acid, tartaric acid, oxalic acid, malic acid oxalacetic acid, and succinic acid.

The foregoing constituents may be combined in a liquid or solid concentrate according to the proportions described above. The liquid concentrate compositions may include effective amounts of 2HOP and derivatives thereof (e.g., salts thereof), L-PGA and derivatives thereof (e.g., salts thereof), and combinations thereof. For example, the liquid concentrate may include of 2HOP and derivatives thereof (e.g., salts thereof), L-PGA and derivatives thereof (e.g., salts thereof), and combinations thereof in an amount in a range of about 1% wt/v (about 0.3 M) to about 43.5% wt/v (about 3M). In some embodiments, the amount of 2HOP and derivatives thereof (e.g., salts thereof), L-PGA and derivatives thereof (e.g., salts thereof), and combinations thereof present in the composition is between about 10% wt/v (about 0.670 M) and about 30% wt/v (about 2.07 M). In embodiments in which the composition includes both (1) 2HOP and/or derivatives thereof, and (2) L-PGA and/or derivatives thereof, the ratio between (1) 2HOP and/or derivatives thereof, and (2) L-PGA and/or derivatives may be in a range of about 1:1 to about 1/10 (e.g., in a range of about 1:3 to about 1:7, in a range of about 1:5 to about 1:7, or any value or range of values therein).

In some embodiments, the invention provides a dilution of the concentrate composition, comprising the composition of the invention dissolved in water or other aqueous solution. The dilution composition may include effective amounts of 2HOP and derivatives thereof (e.g., salts thereof), L-PGA and derivatives thereof (e.g., salts thereof), and combinations thereof. For example, the liquid concentrate may include of 2HOP and derivatives thereof (e.g., salts thereof), L-PGA and derivatives thereof (e.g., salts thereof), and combinations thereof in a dilution having a volume of about 200 L to about 300 L, or any value or range of values therein. In some embodiments, the amount of 2HOP or functional derivative thereof present in the formulation is between about 0.02 g/L (about 0.138 mM, about 0.002% wt/v) to about 5 g/L (about 34 mM, about 0.5% wt/v), e.g., about 0.1 g/L (about 0.689 mM, about 0.01% wt/v) to about 1 g/L (about 6.70 mM, about 0.10% wt/v); about 0.2 g/L (about 1.38 mM, about 0.02% wt/v) to about 2 g/L (about 13.8 mM, about 0.2% wt/v), or any value or range of values therein. In embodiments in which the composition includes both (1) 2HOP and/or derivatives thereof, and (2) L-PGA and/or derivatives thereof, the ratio between (1) 2HOP and/or derivatives thereof, and (2) L-PGA and/or derivatives may be in a range of about 1:1 to about 1:10 (e.g., in a range of about 1:3 to about 1:7, in a range of about 1:5 to about 1:7, or any value or range of values therein).

In some embodiments, the composition may be a suspension concentrate including the foregoing constituents in the proportions described above. In such embodiments, the composition may further comprise one or more solid carriers, thickening agents, or bulking agents. Such carriers may be, inorganic mineral earths, such as silica gels, silicates, talc, kaolin, Atta clay, bentonite, limestone, lime, chalk, loess, clay, dolomite, diatomaceous earth, calcium sulfate and magnesium sulfate, magnesium oxide, attapulgite, montmorillonite, mica, vermiculite, synthetic silicic acids, amorphous silicic acids, and synthetic calcium silicates, or mixtures thereof, and/or organic carriers, such as hydrocolloids, polymers, cellulose/methylcellulose powders. The suspension concentrate may further comprise humectants, emulsifiers, anticaking agents, suspending agents, freezing point depressants, antimicrobial agents, and the like. In some embodiments, the amount of 2HOP and derivatives thereof (e.g., salts thereof), L-PGA and derivatives thereof (e.g., salts thereof), and combinations thereof present in the suspension concentrate composition may be between about 1% wt/v (about 0.3 M) to about 43.5% wt/v (about 3M). In some embodiments, the amount of 2HOP and derivatives thereof (e.g., salts thereof), L-PGA and derivatives thereof (e.g., salts thereof), and combinations thereof present in the composition is between about 10% wt/v (about 0.670 M) and about 30% wt/v (about 2.07 M). In embodiments in which the composition includes both (1) 2HOP and/or derivatives thereof, and (2) L-PGA and/or derivatives thereof, the ratio between (1) 2HOP and/or derivatives thereof, and (2) L-PGA and/or derivatives may be in a range of about 1:1 to about 1:10 (e.g., in a range of about 1:3 to about 1:7, in a range of about 1:5 to about 1:7, or any value or range of values therein).

In some embodiments, the composition may be a solid composition. The solid composition may be a dry, granulated, or flowing composition intended for dispersion or for dissolution in aqueous solution prior to delivery to plants. Dry fertilizer compositions may be highly water-soluble. In other contexts, dry fertilizer compositions may provide for slow release (as by low water-solubility or by encapsulation), such as when the steady or controlled delivery of nutrients over time is desired. The solid composition may include an amount of 2HOP and derivatives thereof (e.g., salts thereof), L-PGA and derivatives thereof (e.g., salts thereof), and combinations thereof in a range of about 1 wt/wt and about 15 wt/wt. In embodiments in which the composition includes both (1) 2HOP and/or derivatives thereof, and (2) L-PGA and/or derivatives thereof, the ratio between (1) 2HOP and/or derivatives thereof, and (2) L-PGA and/or derivatives may be in a range of about 1:1 to about 1:10 (e.g., in a range of about 1:3 to about 1:7, in a range of about 1:5 to about 1:7, or any value or range of values therein). The solid formulation according to the invention may comprise one or more solid carriers in an amount in a range of about 30 wt % to about 60 wt % (e.g., an amount in a range of about 40 wt % to about 55 wt %, an amount in a range of about 45 wt % to about 50 wt %, or any value or range of values therein). The presence of one or more solid carriers in the suspension concentrate composition permits a stable homogeneous matrix for the composition.

### Methods:

Methods of Use

The present invention relates to methods for improving the growth, yield, nutrient use efficiency, disease resistance (fungal, bacterial, etc.), parasite resistance, biotic stress resistance, and abiotic stress resistance of plants through application of the compositions described herein to plants. Methods of the present invention include increasing a growth characteristic of a plant comprising applying a composition as described herein to a plant, or a growth medium of a plant. In exemplary embodiments of the invention, the methods will result in an increase in biomass, foliar tissue weight, number of seed heads, number of tillers, number of flowers, number of tubers, tuber mass, bulb mass, number of seeds, total seed mass, rate of leaf emergence, rate of tiller emergence, rate of seedling emergence, harvestable seed, fruit or nut yield, and/or plant protein and starch content. The compositions and methods of the present invention can be significantly economically advantageous, as the increase in growth characteristics may result in increased yield in harvestable crops and more robust plants. The various embodiments of the composition of the present invention may be applied to the stems, leaves, seeds, roots, cultivars, propagation material, and/or other portions of the plant, to the growth medium of the plant, and/or pest plants around the targeted plants. Exemplary methods are discussed below.

Disease Suppression

Applicants have found that 2HOP and derivates thereof, L-PGA and derivates thereof, and combinations thereof are operable to suppress plant diseases caused by fungi and bacteria. It has been found that this effect is primarily plant-mediated. The formulations of the invention can be used to treat plants that are already infected or may become infected with fungi. The present methods may include treating a plant prophylactically or after disease is observed in the plant.

The formulations of the invention may be used to treat plants that are already infected or may become infected with mycotoxin producing fungi, such as Fusarium, Aspergillus, Penicillium, Strachybotrus, Claviceps and other fungi that produce mycotoxins. Exemplary mycotoxins produced by these fungi include deoxynivalenol, nivalenol, aflatoxin, ochratoxins, citrinin, cyclopiazonic acid, sterigmatocystin, coronatine, and patulin.

The formulations of the invention can be used to treat plants that are already infected or may become infected with bacteria such as Pseudomonas, Salmonella, Escherichia, Xanthomonas, Erwinia, Campylobacter, Shigella, Listeria, Yersinia, Aeromonas, Arcobacter, Vibrio, and Clostridium. Exemplary toxins produced by the bacteria include A-toxin, syringomycin, tabtoxin, phaseolotoxin, coronatine, and proteases.

Important commercial crops that benefit from microbial toxin suppression include both monocots and dicots. Monocots include plants in the grass family (Gramineae), e.g., plants in the sub families Fetucoideae and Poacoideae, which together include several hundred genera including plants in the genera Agrostis, Phleum, Dactylis, Sorgum, Setaria, Zea (e.g., corn), Oryza (e.g., rice), Triticum (e.g., wheat), Secale (e.g., rye), Avena (e.g., oats), Hordeum (e.g., barley), Saccharum, Poa, Festuca, Stenotaphrum, Cynodon, Coix, Olyreae, Phareae, and many others. As noted, plants in the family Gramineae are a particularly preferred target plants for the methods of the invention, which are discussed below.

Additional targets of the present methods include other commercially important crops, e.g., from the families Compositae (the largest family of vascular plants, including at least 1,000 genera, including important commercial crops such as sunflower), and Leguminosae or the “pea family,” which includes several hundred genera, including many commercially valuable crops such as pea, beans, lentil, peanut, yam bean, cowpeas, velvet beans, soybean, clover, alfalfa, lupine, vetch, lotus, sweet clover, Wisteria, and sweetpea. Plants in the genera Fragaria, Lotus, Medicago, Onobrychis, Trifolium, Trigonella, Vigna, Citrus, Linum, Geranium, Manihot, Daucus, Brassica, Raphanus, Sinapis, Atropa, Capsicum, Datura, Hyoscyamus, Lycopersicon, Nicotiana, Solonum, Petunia, Digitalis, Majorana, Cichorium, Helianthus, Lactuca, Bromus, Asparagus, Antirrhinum, Heterocallis, Nemesia, Pelargonium, Panicum, Pennisetum, Ranunculus, Senecio, Salpiglossis, Cucumis, Browaalia, Glycine, Lolium, Zea, Triticum, Sorghum, Malus, Apium, Agrostis, Phleum, Dactylis, Setaria, Oryza, Secale, Avena, Hordeum, Saccharum, Poa, Festuca, Stenotaphrum, Cynodon, Coix, Olyreae, Phareae, Pisum, Cicer, Phaseolus, Lens, and Arachis are targets for mycotoxin detoxification. Common crop plants that are targets for mycotoxin suppression include corn, rice, triticale, rye, cotton, soybean, sorghum, wheat, oats, barley, millet, sunflower, canola, peas, beans, lentils, peanuts, yam beans, cowpeas, velvet beans, clover, alfalfa, lupine, vetch, lotus, sweet clover, Wisteria, sweetpea and nut plants (e.g., walnut, almond, hazelnut, macadamia, peanuts, pistachio, pecan, etc.).

Herbicide Stress Recovery

Genetically modified (GM) and Non-GM crop plants are often stressed by herbicides. Commercial herbicides exploit many different modes of action. Some herbicides are specific to certain types of plants such as monocotyledons (grasses) or dicotyledons (broadleaves). In some applications (post-plant, post-emergent), herbicides are sprayed over the crop plant (GM or non-GM) with the intention of curtailing or destroying weed species. Many GM crop plants have been engineered to resist certain herbicides, such as glyphosate, which effectively targets 5-enolpyruvylshikimate-3-phosphate (EPSP) synthase and is a key enzyme in the biosynthesis of aromatic amino acid in plants. Typically, herbicide resistant crops exhibit some degree of phytotoxicity and/or retardation of crop growth following treatment. This negative effect can account for some crop loss, but is tolerated by farmers due to the greater harm in terms of yield loss inflicted by unchecked weed growth.

The presently disclosed compositions that include 2HOP or derivatives thereof, L-PGA or derivatives thereof, and combinations thereof may be applied to plants before and/or after the application of herbicides to countervail the negative effects resulting from applied herbicides. The growth-enhancing effects of the compositions comprising 2HOP or derivatives thereof, L-PGA or derivatives thereof, and combinations thereof may allow the use of herbicides without loss of yield or plant health.

Abiotic Stress

Abiotic stressors include growing temperatures outside the plant's growing range, high salt concentrations in water or soil, drought stress, and other causes. Abiotic stressors can reduce yields dramatically, kill the plants, and reduce profitability of agricultural crops. Lower growing temperatures are often encountered in the agricultural production of grains, especially during the early portion of the growing season. High salt concentrations in either soil or water are an increasing problem as salt accumulates in irrigated soils and irrigation water with higher salt concentration must be used. The effect of high salt concentrations can be referred to as osmotic stress because the high salt concentrations in soil and water interfere with the transport of ions and water within a plant. Symptoms of high salt stress include inhibition of growth, premature development, senescence, and death.

In many regions, the changing climate has caused atypical shortages of rainfall at times during the growing season causing short-term droughts that limit crop production. Symptoms of drought stress include wilting, yellowing of leaves, burnt leaf tips, dead leaves and leaf drop. Crop yield is reduced in proportion to the severity of the drought.

Cold temperatures stress plants in a number of ways, beginning with poor germination and followed by stunting of seedling growth, yellowing of leaves, reduced leaf expansion, wilting, and tissue death. Cold stress severely inhibits the development of reproductive parts of the plant. Crop yield is reduced in response to cold stress in proportion to the extent of the damage to the plants.

Plants can defend themselves from cold temperatures, high salt content water or soils, and drought by increasing their free pools of proline and soluble sugars. In the example below, treatment with 2HOP or derivatives thereof, L-PGA or derivatives thereof, and combinations thereof increases the pool size of free proline. The treatment can provide plants with increased protection from cold temperatures, high salt content in water or soils, and drought. The present invention includes methods of applying the compositions that include 2HOP or derivatives thereof, L-PGA or derivatives thereof, and combinations thereof to plants before and/or after the plant undergoes abiotic stress, such as high or low temperature stress, stress to salinity, osmotic stress, and other abiotic stress conditions.

Improving Growth Characteristics, Nutrient Use Efficiency, and Carbon Sequestration.

In another implementation, the compositions described herein comprising 2HOP or derivatives thereof, L-PGA or derivatives thereof, and combinations thereof may be applied to plants to increase the growth characteristics of the plant. Plants treated with the compositions of the present invention show increased biomass whilst still maintaining elemental stoichiometry. The application of the compositions of the present invention also results in greater nutrient utilization for N, P, K, Ca, & Mg nutrients.

Nitrogen use efficiency can be examined or defined by nitrogen uptake efficiency by plants and by the internal nitrogen use efficiency. The nitrogen uptake rate can be measured directly by measuring fixed Nitrogen (as amino acids) in plant tissues as well as leaf protein content including Chlorophyll. Treatment with compositions comprising 2HOP or derivatives thereof results in an increased rate of nitrogen uptake and increased de novo biosynthesis of amino acids.

Nitrogen use efficiency can also be examined or defined by the internal utilization efficiency. This is demonstrated by the protein nitrogen in foliar parts (e.g., of cereal grains). The protein in leaves contains approximately 90% of the leaf nitrogen; the vacuolar nitrate pool is approximately 3-4% and other nitrogen-containing compounds have about 3-5% of the total nitrogen in the leaves. Plants treated with the compositions of the present invention comprising 2HOP or derivatives thereof, L-PGA or derivatives thereof, and combinations thereof show greater total nitrogen taken up, assimilated and incorporated into the leaf proteins, indicating a high level of nitrogen utilization efficiency.

The increased biomass and other indicators of greater carbon sequestration that occur in plants treated with the compositions of the present invention comprising 2HOP or derivatives thereof, L-PGA or derivatives thereof, and combinations thereof in turn increases the sequestration of carbon in the treated plants. This is an economically attractive method of carbon sequestration in the soil, since it is paired with greater crop plant biomass. The dry matter biomass remaining after harvest can remain in and on the soil at the end of the crop year to maintain the carbon sequestration in the treated plants. Indicators of greater carbon acquisition by the plants include greater CO₂ fixation activity, greater dry weight to fresh weight ratio, and overall biomass. Another indicator of carbon fixation is the activity of ribulose bisphosphate carboxylase (RUBISCO), the major carbon-fixing enzyme. 2HOP increases CO₂ fixation activity and RUBISCO activity and increases overall biomass. Plants treated with the compositions of the present invention grow larger and contain more carbon per gram of fresh weight, e.g., as measured by dry-weight-to-fresh-weight ratio. Approximately 90% of such plant dry matter is carbon-containing molecules.

Treatment of Fungal and Bacterial Infections

The methods of the present invention include applying the disclosed compositions comprising 2HOP or derivatives thereof, L-PGA or derivatives thereof, and combinations thereof to plants to suppress fungal and bacterial diseases, as well as the suppression of associated microbial toxins that result of fungal and/or bacterial infections. The methods of the present invention further include applying the disclosed compositions comprising 2HOP or derivatives thereof, L-PGA or derivatives thereof, and combinations thereof in combination with biocides to plants suppress fungal and bacterial diseases and microbial toxin production. Cooperative interactions of these novel formulations in combination with biocides (e.g., fungitoxic pesticides, or bacteriotoxic pesticides) have important commercial implications due to decreasing availability of registered disease control agents and increasing lack of efficacy in such biocide products.

For example, it has been observed that certain fungicides (e.g., strobilurins) not only are affected by a loss of efficacy due to the development of tolerance in the target organisms but can also cause the production of elevated levels of mycotoxins when applied to cereals infected with Fusarium graminearum. Strobilurins are commonly utilized in commercial settings because of their potent disease control capability and concomitant increase in crop yield. However, upon exposure to strobilurins, Fusarium produces an array of mycotoxins such as deoxynivalenol (DON), nivalenol, and fumonisin. Thus, treatment of Fusarium-induced “head blight” in wheat with strobilurins increases the level of mycotoxins in the treated plant. When biocides such as strobilurins are combined with compositions comprising 2HOP, L-PGA, or both 2HOP+L-PGA, the level of mycotoxin production detectably decreases. The synergistic effect between the fungicide and the compositions comprising 2HOP, L-PGA, or both 2HOP+L-PGA mitigates the detrimental properties of strobilurins on microbial toxin production, enhancing the utility of the strobilurins in disease control.

The application of compositions comprising 2HOP or derivatives thereof, L-PGA or derivatives thereof, and combinations thereof to microbes decreases detectable microbial toxin (i.e., by suppression of synthesis or detoxification) by at least about 10%, (e.g., by at least about 20%, by at least about 30%, by at least about 40%, by at least about 50%) more than the individual application of an essentially identical amount of the components of the composition to the microbe (e.g., 2HOP or L-PGA alone). The application of compositions comprising 2HOP or derivatives thereof, L-PGA or derivatives thereof, and combinations thereof to a microbe also reduces the synthesis of microbial gene products involved in biosynthesis of microbial toxins.

Nematode Suppression

Nematodes are a major biotic pest of agricultural and horticultural crops. Due to their inherent toxicity to animals, few nematicides are currently available for chemical management and those that remain have limited efficacy. Hence, there is a great need for effective methods of nematode control. The compositions of the present invention comprising 2HOP or derivatives thereof, L-PGA or derivatives thereof, and combinations thereof are operable to enhance the effect of Nematode control agents. The present methods include applying the presently disclosed compositions to plants to suppress nematode infection, while having a minimal effect on free-living (beneficial nematodes). L-PGA and 2-HOP have low toxicity and may not have a negative impact on beneficial nematodes and selectively attack parasitic nematodes. This is a valuable benefit due to the role beneficial nematodes play in soil ecology.

The compositions may be applied to the plant in combination with a nematicide, such as oxamyl-based nematicides, fluensulfone-based nematicides, fluopyram-based nematicides, ethoprop-based nematicides, and other available nematicides.

### Example 1

Effect of Compositions Comprising 2HOP, L-PGA, and 2HOP+L-PGA Alone or in Combination with Fungicides for the Suppression of Diseases of Cereals

To eliminate possible bacterial contamination, a field isolate of Zymoseptoria tritici (Septotia tritici) was grown on potato dextrose agar (PDA), amended with penicillin and streptomycin for 6 days at 20° C. Fungicide activity comparisons against a current strain of the pathogen, which is very likely to carry recent insensitivity mutations.

Spore suspensions were made by flooding the plates with sterile distilled water and scraping gently. The spore suspensions were adjusted to 10⁶ conidia mL⁻¹ by haemocytometer counts and appropriate dilution, before final re-suspension in 50% potato dextrose broth, amended with 1.5 g L⁻¹ gelatin and 0.5 g L⁻¹ sodium oleate.

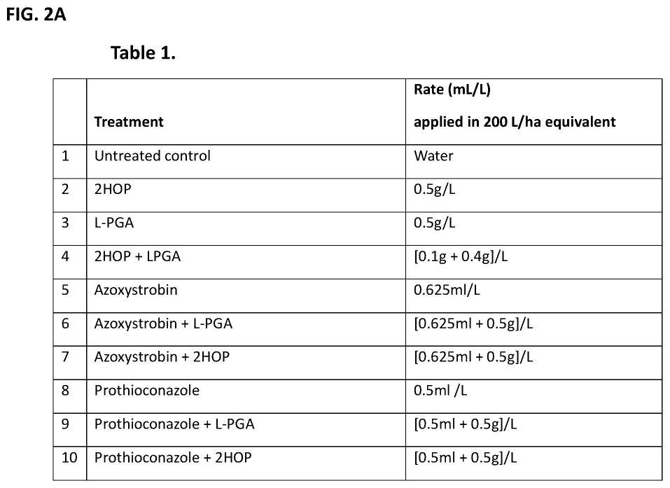

Septoria-susceptible winter wheat cv Trinity was planted in Levington M3 compost. A total of 15 seeds were planted per 9 cm pot and grown to growth stage 12. Plants were accommodated in a glasshouse with day heating to 20° C., venting at 20° C., and night heating to maintain 15° C. Plants were inoculated with Z. tritici by spraying spore suspensions at 10⁶ spores mL⁻¹ to just before run-off. Two replicate pots were used per treatment. The plants were placed in sealed, transparent propagators for 72 hours, to maintain high relative humidity and to ensure free water remained on leaves. Shading was provided to ensure the plants did not overheat within the propagators. Preventative treatments were made 1 day before inoculation and curative fungicide applications were made 5 days after inoculation (Prothioconazole=Proline® 480 SC applied at 0.5 mL/L water; Azoxystrobin=Quaris® applied at 0.625 mL/L). All treatments had 0.25% v/v of a polyalkylglycoside wetting agent assigned to the spray tank. Treatments were randomized within the glasshouse. All fungicides were applied at the equivalent rate of 200 L water per hectare, using a calibrated pressurized hand-held sprayer. This was achieved by placing plants to be treated in a 1 m² area and applying 20 mL of fungicide sprays. Treatments used were as given in the Table 1 in FIG. 2A.

Disease assessments were made 21 and 22 days after inoculation (DAI), by scoring the area of 30 replicate inoculated leaves (leaves 1 and 2) showing Septoria necrosis. As the conditions were highly conducive to disease symptoms were visible by 18 DAI, but assessment was delayed allowing severe disease to develop in untreated controls and to provide a stringent test for the fungicides. Plants were scored in a random sequence using a key which scored leaves as 0, 1, 5, 10, 25, 50, 75, or 100% necrotic. See Table 2 in FIG. 2B.

### Example 2

The Effect of 2HOP or L-PGA or the Combination of them on Growth of a Fungal Plant Pathogen was Examined and the Plant's Innate Resistance was Shown to be Responsible for the Protection from Infection by the Fungal Pathogen.

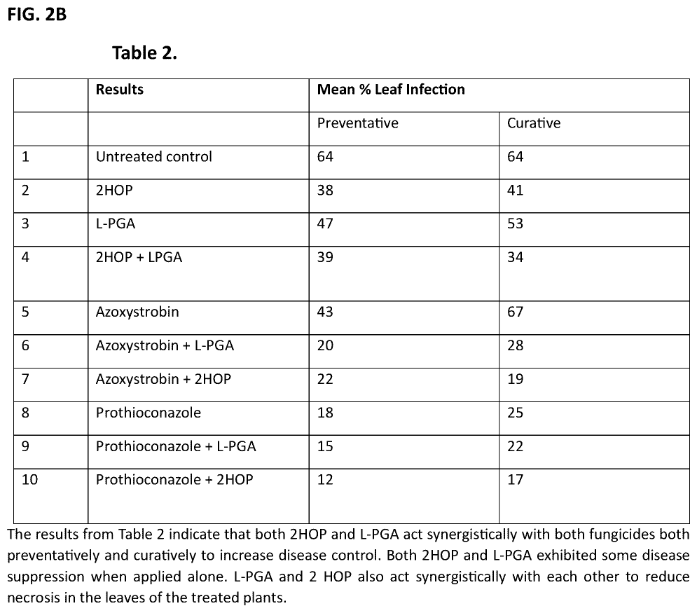

Zymoseptoria tritici (Septotia tritici) was grown in petri dishes on buffered (pH 6.2) potato dextrose agar (PDA), amended with penicillin (100 mg/L) and streptomycin (100 mg/L) as well as 2HOP (0.5 g/L) or L-PGA (0.5 g/L). Five replicate plates/treatments were used and the cultures were grown for 10 days in darkness at 68° F. At the end of the 10-day period, the cultures were assessed in terms of the total surface area of growth of the colonies. See Table 3 in FIG. 3A.

These data indicate that the disease suppression responses to treatment of plants with 2HOP and L-PGA are host-mediated (Table 3), and that there is no direct suppression of fungal growth due to the application of 2HOP or L-PGA. This is further supported by the data in Table 4 where foliar treatment of lettuce plants with L-PGA (0.5 g/L) or 2HOP (0.5 g/L) increased the tissue levels of aromatic amino acids which are synthesized in the Shikimic acid pathway, a pathway that has a known role in modulation of plant innate tolerance to abiotic and biotic stresses such as disease. See Table 4 in FIG. 3B.

### Example 3

Suppression of Mycotoxin Expression in Wheat Plants Infected with Fusarium graminearum Schwabe Group 2, the Causal Fungus of Fusarium Head Blight (FHB)

Seeds of the soft red winter wheat cultivar Pioneer Brand 2545 (FHB susceptible) were planted (1 g seeds/pot) into 6-inch diameter pots containing autoclaved coarse river sand, housed in a climate-controlled greenhouse with plastic humidity bags. Each pot was treated with a top dressing 0.5 g of Osmacote® 90-day complete slow-release fertilizer mix and this was re-applied every two weeks. Plants were grown between 50-60° F. (night) and about 75° F. to about 80° F. (day) under natural light conditions. Plants were irrigated every 3 days. The plants were allowed to grow over the course of 80 to 90 days until the onset of flowering. Plants received foliar applications of 2HOP (1 g/L); 2HOP (0.15 g/L) and L-PGA (0.85 g/L); L-PGA (1 g/L); and L-PGA (1 g/L)+calcium phosphite (5 g/L); and calcium phosphite (5 g/L). Application of the treatments occurred at Zadoks growth stage 35 to 37 (flag leaf) and again one week prior to flowering and immediately after the removal of the plastic humidity bags as described below.

Fusarium graminearum (G. zeae isolate Z-3639) was grown in petri dishes on V8 juice agar (CV8 agar) under 12 h/day fluorescent light for 7 days at 24° C. Suspensions of macroconidia were obtained by flooding of the petri dishes with sterilized phosphate buffer and gently dislodging the conidia using a sterile inoculating loop. The eventual conidial concentration was adjusted to 7.2×10⁵ conidia/ml in accordance with Schisler et al., Biological Control 39, 497-506 (2006).

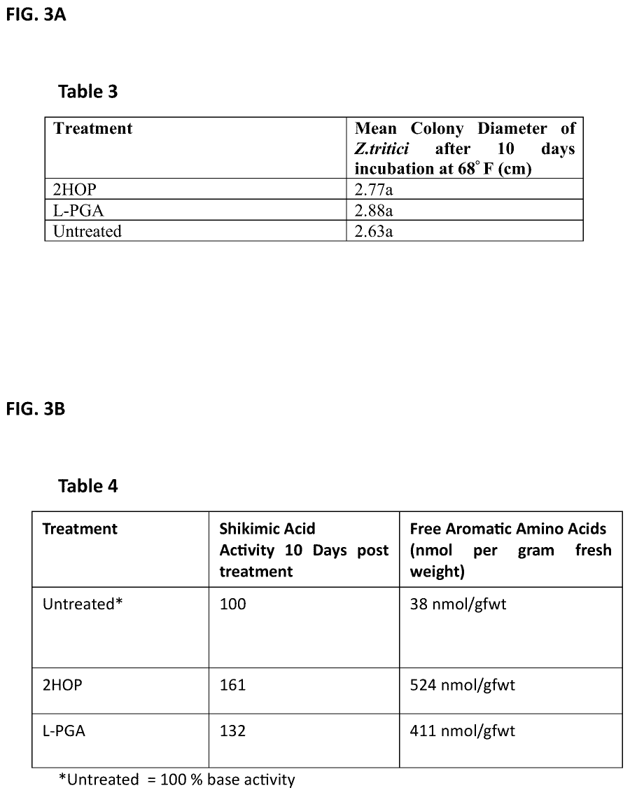

Conidial suspensions were then misted until run-off onto all the flowering wheat heads in each treatment replicate (6 pots per treatment) using a Crown Spra-Tool Kit air assist sprayer. Each pot was covered with a plastic bag and the greenhouse temperature was maintained at 80° F. for 3 Days after which the bags were removed, and the plants scored for disease severity two weeks later using a 0-100% scale. The plants were maintained until harvest and assessed for mycotoxin contamination of seed. Specifically, DON levels in seed heads were assessed by using an ELISA-based detection system. AgraQuant® ELISA DON mycotoxin test kits were used (catalogue number COKAQ4000 from Romer labs, Newark, DE, USA). Sample preparation includes: 3 g of grain from each treatment replicate was collected and pooled with the other treatment replicates. Each pooled treatment (comprising of 6 replicates) was thoroughly mixed with 200 mL of distilled water in a beaker and the sample was macerated with a tissue homogenizer for 30 seconds. The sample was filtered using Whatman #1 filter paper to obtain a clarified extract. 0.1 mL of this extract was placed into one well of the supplied ELISA plate and processed according to the manufacturer's instructions. Five wells were used per treatment. Positive and negative controls were also plated into the ELISA plates. The plates were incubated for 5 minutes at room temperature and assessed by using an ELISA plate reader at 450 nm wavelength. See Table 5 in FIG. 4.

All treatments reduced DON grain levels. Calcium phosphite alone or with L-PGA resulted in the largest reduction in DON (See FIG. 4 Table 5).

### Example 4

The Effects of L-PGA Alone or in Combination with a Nematicide on Yield from Grapevines Grown in Nematode Infested Soil, and on the Nematode Populations.

Grapevines were treated with L-PGA alone or in combination with Nemacur® at two sites in California. L-PGA was applied by drenching the roots with a solution (5 liters per plant) containing 1 g/L L-PGA. Nemacur® 400ec was applied as a labelled commercial treatment to specific rows at the trial locations by injection through the micro irrigation system (7.5 ml/vine). Each treatment comprised 20 vines in five replicate blocks (4 vines/replicate). Vines at both sites were 6 years old and replanted into sandy soil (CEC <7 meq/100 g soil) previously planted with vines. Site 1 was in Madera County (var; Zinfindel) and had a history of Root Knot nematode infestation (Meloidogyne incognita, M. javanica, M. arenaria, and M. hapla) and extensive root galling was evident. Site 2 was in Fresno County (var: Thompson seedless) and at this site several parasitic nematode species were in evidence (Table 8). Several treatments were undertaken as per Tables 6 & 7. Untreated vines received the standard grower cultural management programs. At both sites the plants were ungrafted. At Site 1, soil levels of nematodes were assessed prior to the onset of treatments and at various times throughout the trial (as given in Table 7). Plants were treated in the spring, summer, and fall and assessed 12, 13, 15 and, 24 months later at Site 1. Yield data were collected at both sites. Site 1 was treated for two seasons and yield was collected over two seasons. At Site 2, yields were collected and soil nematode levels were assessed 18 months after the onset of the treatments. Site 2 was only treated for one season and only one crop year was assessed.

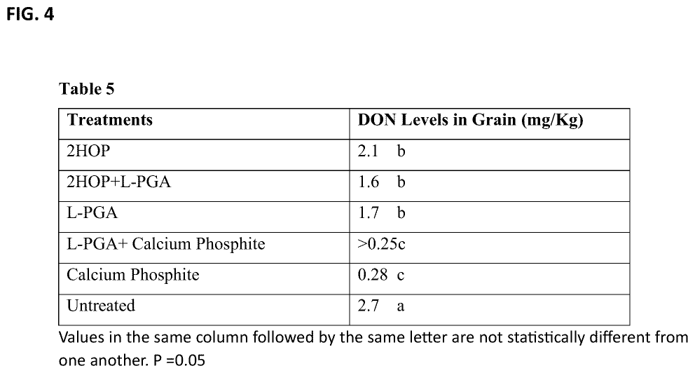

L-PGA in combination with Nemacur® resulted in the highest yield (Table 6). L-PGA individually and Nemacur® individually elevated yield compared to the untreated vines. See Table 6 in FIG. 5A. L-PGA in combination with Nemacur® resulted in the greatest reduction in soil Root Knot nematode populations. L-PGA as well as Nemacur® alone also reduced soil Root Knot nematode populations after 15 months (see Table 7). See Table 7 in FIG. 5B. At site 2, L-PGA had a minimal effect on free-living (beneficial nematodes) which was expected due to its low toxicity. This is a valuable benefit due to the role beneficial nematodes play in soil ecology. What was unexpected was the finding that L-PGA increased the efficacy of a conventional nematicide such as Nemacur® (Table 8) in terms of soil plant parasitic nematode population suppression. See Table 8 in FIG. 5C.

### Example 5

The Effects of 2HOP and L-PGA when Combined with Herbicides on Herbicide Phytotoxicity.

Wheat (Winter White) seeds (5 g) were sown in a 1-gallon pot in a greenhouse under natural light with a diurnal temperature range of 75° F. to 90° F. Various herbicides were applied alone or in combinations with L-PGA or 2HOP. Materials were applied at the equivalent rate of 100 L water/Ha with 0.25% v/v polyalkyl glucoside added as a wetting agent. There were 4 replicates per treatment, with 1 pot/replicate. 10 days after sowing, plants received a light cover spray at an equivalent application volume of 25 gallons/acre. Plants were destructively assessed 10 days later by measuring the total above-ground biomass of each replicate. Treatments are shown in Table 9.

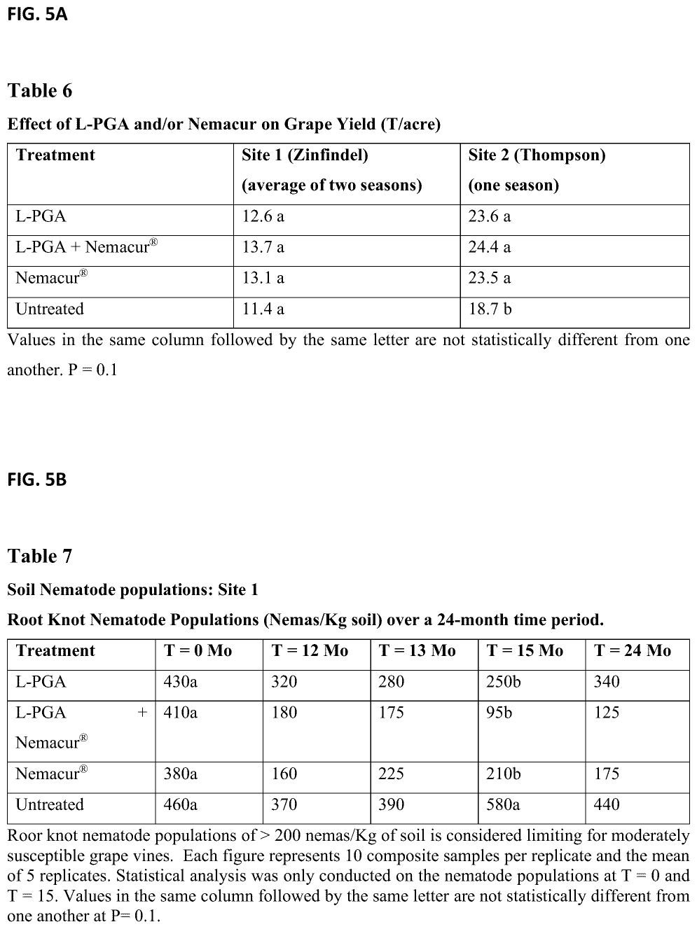

All the herbicides used in this experiment are commonly used in wheat to primarily control broad leaf weeds. When used according to the label, these herbicides can induce stunting chlorosis and yield loss (see FIGS. 1 & 2), as has been reported. These results clearly indicate a suppression of the phytotoxic impact of these herbicides on wheat when combined with 2HOP or L-PGA. See Table 9 in FIG. 6A. FIG. 6B shows the effects on the growth of wheat even as early as one day post application. Treatments 4 and 6 induced the greatest stunting of the wheat.

FIG. 6C, shows the results of selected herbicide treatments with and without 2HOP and L-PGA on wheat growth 10 days after treatment. At 10 days post-treatment, 2HOP and L-PGA solo applications resulted in a visual increase in canopy biomass as compared to the untreated (FIG. 2-3 & FIG. 2-2 vs. FIG. 1-1). When these treatments were combined with the herbicide treatments, a numerical and visual reduction in phytotoxicity was apparent.

### Example 6

Effects of 2-hydroxy-5-oxoproline on Proline Accumulation, an Amino Acid that Increases Tolerance of Abiotic Stresses Caused by Cold Temperatures, High Salt (Osmotic Stress), or Drought

Sets of oat seedlings were grown and either treated or not treated with 2-hydroxy-5-oxoproline. The plants were grown in a greenhouse at 75° F. with ambient light and provided a standard complete nutrient plant food. Weekly foliar treatments were applied with 100 micromolar 2HOP began at the two-true leaf stage and continued for 3 weeks. Leaves from 20 plants were sampled and the free pools of proline were measured.

The 2HOP-treated plants contained free proline pools 2.6 micromol/g fwt. The free proline pools in the leaves of the untreated plants were undetectable. Proline has been previously shown to increase the tolerance of plants to abiotic stress such as low temperatures, drought stress, and salinity.

### Example 7

### The Effects of 2HOP or L-PGA on Cold Tolerance in a Cold Sensitive Plant

The popular ornamental plant, the “Peace Lily”, is in the genus Spathiphyllum and all species are indigenous to the tropics. As such they are cold sensitive and generally do not tolerate temperatures below 40° F., exhibiting progressive discoloration, senescence, and tissue death as temperatures approach freezing.

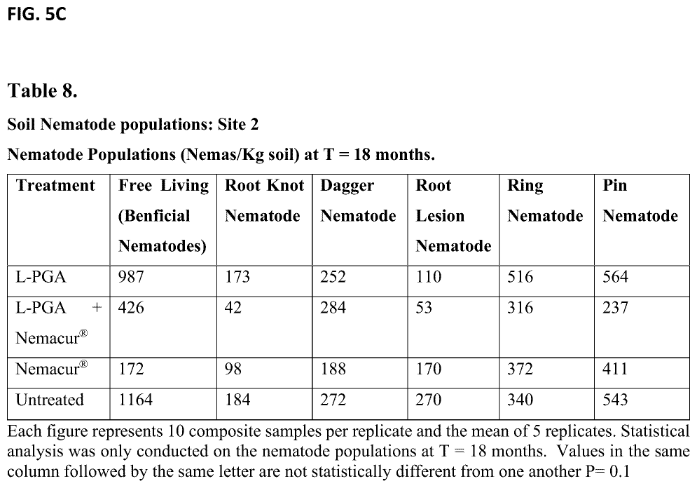

Three groups of containerized plants (in 6-inch pots, growing in a standard potting media) were established, and foliarly treated with 1 g/L 2HOP or LPGA. A surfactant (polyalkyl glucoside) at 0.25% v/v was added to both treatments to improve leaf coverage. Plants were treated and one week later were exposed 4 days to a diurnal regime of low temperatures (34° F. to 35° F.) for at least 5-6 hours/day and a high temperature of 55° F. to 57° F. for the remainder of the day. Plants were under a natural light regime. Plants treated with 2HOP, or L-PGA exhibited less cold damage than the untreated plants. See Table 10 in FIG. 7A and FIG. 7B.

### Example 8

The Effects of Different Combinations of 2-hydroxy-5-oxoproline and L-Pyroglutamate Provided to Greenhouse-Growth Wheat on Numbers of Tillers, which is Directly Correlated with Yield and is an Indicator of Good Plant Growth.

The number of tillers was tracked in sets of twenty wheat (var. Glenn) seedlings that were either treated or untreated or left untreated with combinations of 2HOP and L-PGA. Seedlings were grown in a greenhouse at 75° F. under ambient light and provided a standard complete nutrient solution. Two different combinations of 2HOP were used in the treatment solutions: one contained 20 micromolar 2HOP and 80 micromolar L-PGA and the second treatment solution contained 10 micromolar 5-hydroxy-5-oxoproline and 90 micromolar 2HOP and 90 micromolar L-PGA. The seedlings were given one foliar treatment with one of the treatment solutions at the beginning of the three true leaf stages. Tiller numbers were counted beginning when tillers began to emerge.

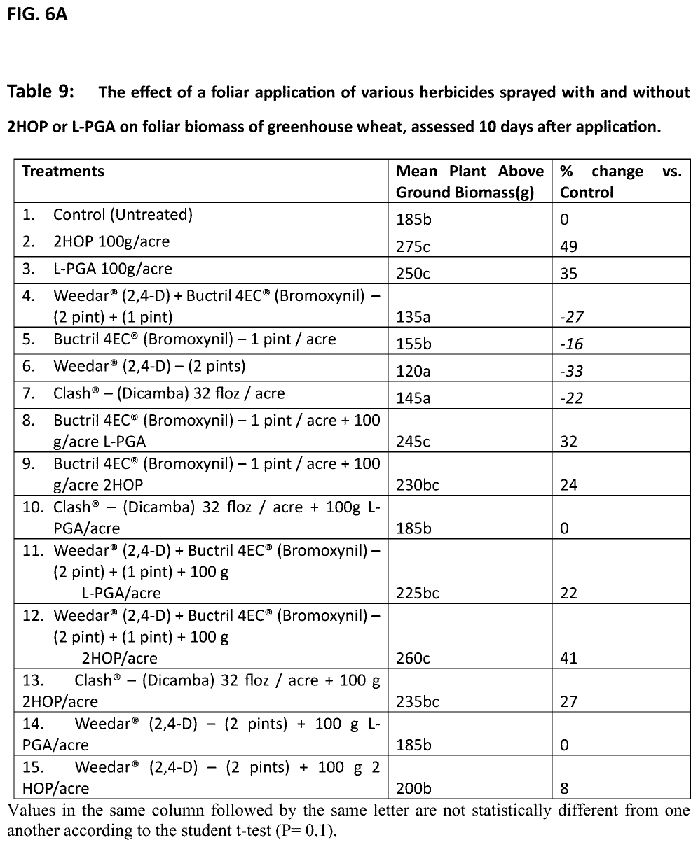

Tillers emerged earlier and in greater numbers in the treated plants when compared with untreated plants (see Table 11). The early tillers mature earlier and develop larger heads that contain greater numbers of seeds. The number of tillers is directly related to yield in cereals. This data were analyzed using a Student's t-test. The comparisons of tillers on untreated with treated had p values <0.04. These results demonstrate that the tillering response was not only earlier as a response to the treatments, but also a statistical increase in the number of tillers was evident. Tillering in small grains is the main driver of yield. See Table 11 in FIG. 8.

### Example 9

Effects of 2-hydroxy-5-oxoproline on Nutrient Use Efficiency as a Function of Nitrate Uptake Rate, an Indicator of Better Plant Growth.

Oat seedlings were either treated or untreated and their rates of nitrogen uptake were measured. Oat seedlings were hydroponically grown in a greenhouse under ambient light at 75° F. with a complete standard soluble nutrient solution. They were acclimated to constant light, then deprived of nitrogen for a period, and then their nitrogen (nitrate) was replenished with or without 2HOP in the nutrient solution. The plant root systems were submerged in the appropriate solutions and the plants were allowed to grow and take up nitrate. The depletion of nitrate from the solution was measured every four hours to determine the rate of nitrate uptake by the plants.

2HOP-treated oat seedlings had approximately double the rate of nitrate uptake than their untreated counterparts (11.5 vs 5.8 umol/gfwt/h) for the first four hours of treatment.

### Example 10

Effects of the Combination of 2-hydroxy-5-oxoproline and L-Pyroglutamate on Below-Ground Biomass, an Indicator of Plant Growth and Carbon Sequestration.

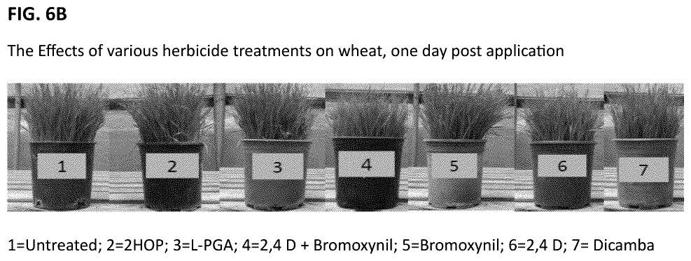

Winter wheat, variety Siskin, was grown to the four-leaf stage in a greenhouse with ambient lighting at 20° C. during the day and 15° C. during the night. The plants were grown to the four-leaf stage and treated with 2HOP plus L-PGA as a foliar spray as an aqueous solution. The plants were harvested 28 days after the second leaf emergence. The roots were dried at 70° C. for three days. The 2HOP+L-PGA treatment increased root biomass. See Table 12 in FIG. 9.

### Example 11

Effects of 2-hydroxy-5-oxoproline on the Growth and Carbon Sequestration Factors of Dry Weight and Carbon Fixation Capability in Lettuce

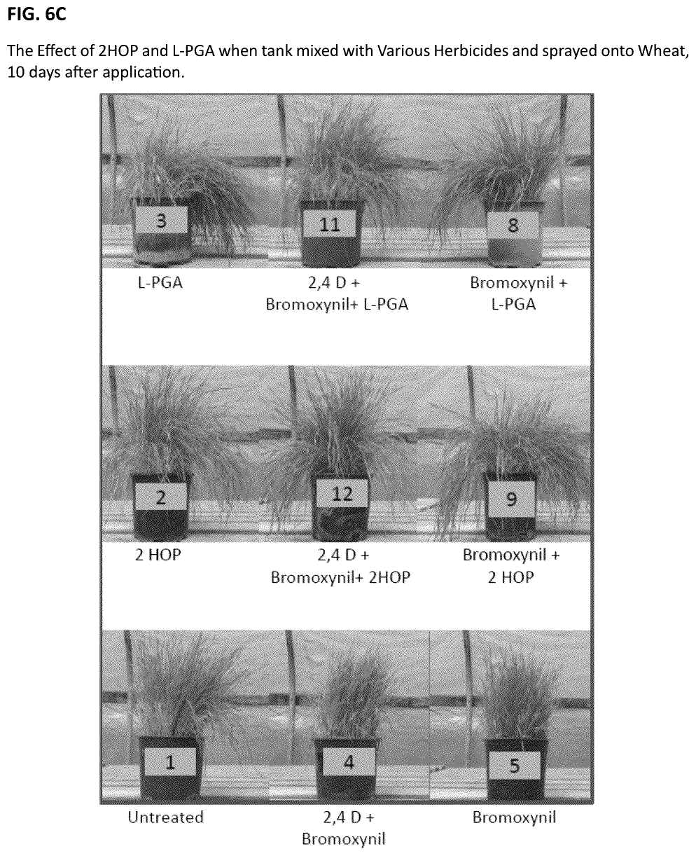

Sets (replicates) of leaf lettuce seedlings were treated with 2HOP or left untreated. Seedlings were grown in a greenhouse (75° F.) with ambient light, supplied with a standard liquid nutrient solution. The treated plants received weekly foliar sprays containing 100 micromolar 2HOP. Each replicate contained 20 plants in a tray. All plants were assessed for each prescribed parameter. For all parameter values vs control p=<0.05. RUBISCO is ribulose bisphosphate carboxylase, the major carbon-fixing enzyme. Table 13 indicates that the 2HOP treatments elevated biomass (on average across all biomass parameters, 34%), CO₂ fixation (>50%), and RUBISCO activation (129%). See Table 13 in FIG. 10.

### Example 12

Effects of Soil Application of 2-hydroxy-5-oxoproline or L-Pyroglutamate on the Carbon Fixation Capability in Greenhouse Grown Oats

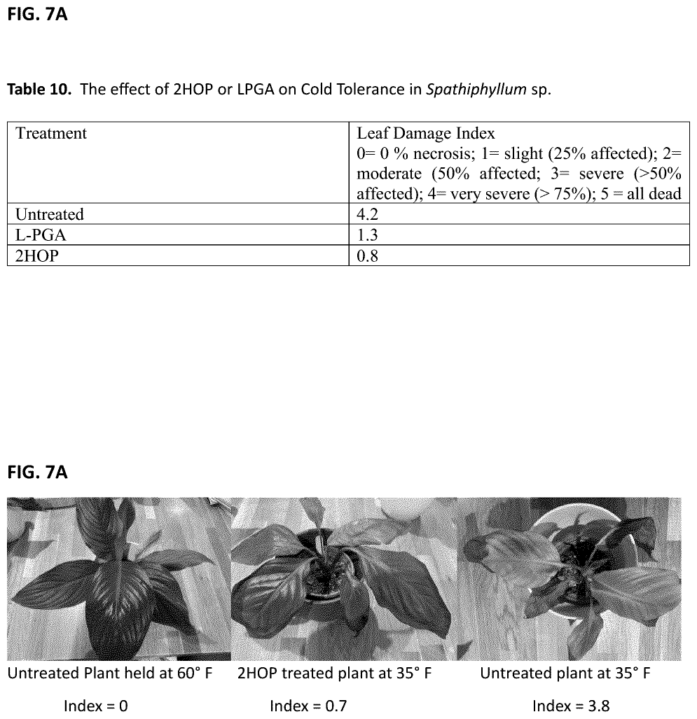

Sets (replicates) of oat seedlings were treated with 2HOP, L-PGA, or left untreated. Seeds were planted in standard potting soil in a greenhouse at a constant 75° F. under natural light, supplied a standard liquid nutrient solution, and treated daily with 75 nanomoles of either 2HOP or L-PGA beginning 14 days after seedling emergence. The treatments were applied as a soil drench. The CO₂ fixation rates were measured when plants were 28 days old. The ribulose bisphosphate carboxylase (RUBISCO) activation state was measured when plants were 26 days old. The rates for 20 plants were averaged for each set of plants. For values vs control, p=<0.05. For 2HOP vs LPGA-treated, p=<0.05. 2HOP increased RUBISCO activation and CO₂ fixation by 48% and 34%, respectively. L-PGA increased CO₂ fixation compared to the untreated by 21%. However, when 2HOP is compared to L-PGA in terms of CO₂ fixation, 2HOP fixed CO₂ at over an 11% higher rate (see Table 14). See Table 14 in FIG. 11.

### Example 13

Effects of 2-hydroxy-5-oxoproline on Nitrogen Use Efficiency as a Function of Leaf Protein Content

Sets of oat seedlings were treated or untreated with 2HOP and the total foliar protein content was compared. Seedlings were greenhouse-grown at 75° F. under ambient light and provided a standard complete nutrient. The seedlings were given three weekly foliar treatments with 2HOP (100 micromolar) beginning at the two-true leaf stage.

The foliar protein concentration in the treated plants was 8.8 mg/g fresh weight compared to only 6.0 mg/g fresh weight for the control plants. The total foliar fresh weight of the treated plants was 183% of the control plants. Therefore, the total protein in the foliar parts of the treated plants was 252% of that of the untreated control plants. Thus, the fixed nitrogen content in the foliar parts of the treated plants was also 252% of the untreated control plants.

### Example 14

Effects of 2HOP, L-PGA, and 2HOP+L-PGA on Leaf Tissue Nutrient Levels, Nutrient Stoichiometry, Total Nutrient Taken Up and Incorporated into Plant Leaves of Greenhouse-Grown Tomato.

Tomato plants were grown from seedlings for eight weeks in a greenhouse with ambient light at a 75° F. constant temperature. All plants received a standard fertigation treatment. Plants were destructively assessed at 8 weeks. Each treatment had twenty single-plant replicates. Plants were treated with foliar applications of 2HOP (1 g/L water), 2HOP+L-PGA (0.5 g+0.5 g/L water), or L-PGA (1 g/L water). Each plant received approximately 50 ml of spray solution (sprayed to drip). All treatments included a wetting agent (polyalkyl glucoside) at 0.025% v/v addition. Plants received a light, cover spray at week 4.

At harvest, a composite leaf sample (10 leaves/plant, 200 leaves total) from each tomato treatment was collected, pooled with the other replicates and assessed for elemental content. The treatment affects on biomass, nutrient uptake, nutrient stoichiometry, number of leaves, leaf area index, and dry weight of the plants. The data are presented in Tables 15, 16, and 17.

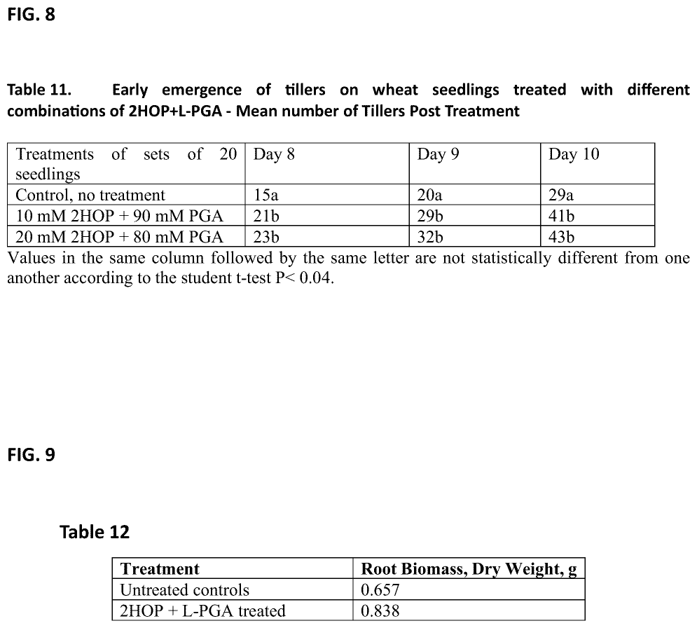

In terms of the leaf elemental composition of the tomato treatments, the treated and the untreated were all within normal levels generally found in tomato leaf tissue. Generally, all treatments resulted in some elevation of tissue elemental levels with respect to N, P, K, and S. See Table 15 in FIG. 12A.

The ratios of the nutrients to one another were maintained; thus, the plants maintained a normal stoichiometry of these nutrient elements. See Table 16 in FIG. 12B. Maintenance of the normal elemental stoichiometry in plants is critical for optimizing plant metabolism. All treatments increased the total amount of N, P, K, and S taken up by the plants in relation to total plant biomass. See Table 17 in FIG. 12C.

### Example 15

### Effects of 2HOP, L-PGA, and 2HOP+L-PGA on Leaf Numbers, Leaf Area Index, and Dry Weight of Greenhouse-Grown Tomato and Pepper Plants

Pepper and tomato plants were grown from seedlings for eight weeks in a greenhouse with ambient light at a constant 75° F. temperature. All plants received a standard fertigation treatment. Plants were destructively assessed at eight weeks. Each treatment had 20 single-plant replicates. Plants were treated with foliar applications of 2HOP (1 g/L water), 2HOP+L-PGA (0.5 g+0.5 g/L water), or L-PGA (1 g/L water). Each plant received approximately 50 ml of spray solution (sprayed to drip). All treatments included a wetting agent (polyalkyl glucoside) at 0.025% v/v addition. Plants received a light, cover spray at week 4.

Plants were assessed in terms of leaf number per plant, leaf area/plant, and total dry weight/plant. In addition, at harvest, a composite leaf sample (10 leaves/plant, 200 leaves total) from each tomato treatment was collected, pooled with the other replicates, and assessed for elemental content which is presented in Table 18.

From the data in Table 18 presented here, it is clear that all the treatments increased the number of leaves, leaf area, and total dry weight. The application of 2HOP alone and in combination with L-PGA resulted in the greatest increases in the measured growth characteristics. See Table 18 in FIG. 13.

### Example 16

### The Effects of Seed Treatments of L-PGA, 2HOP, and 2HOP+L-PGA on Greenhouse-Grown Wheat Leaf Emergence.

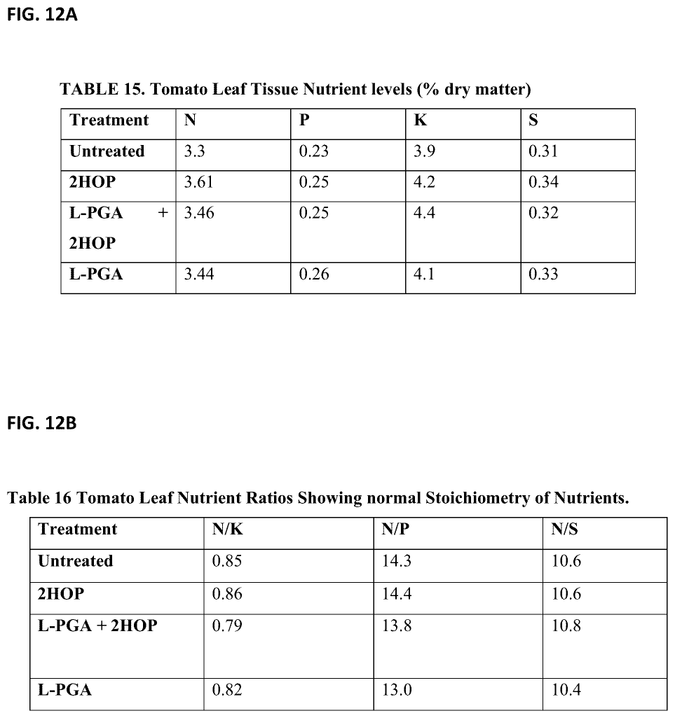

Hard Red Wheat seeds (variety Glenn) were treated with 2HOP, L-PGA, or 2HOP+L-PGA as shown in Table 19, utilizing a commercial bench top seed treater. The treatments were pre-diluted in an equivalent of 2 liters of water and applied to one ton of seed. The seeds were planted in a 30 cm×30 cm flat tray at 1 seed/cm² in a naturally illuminated greenhouse maintained at 65° F. See Table 19 in FIG. 14.

Seed Treatment with 2HOP, L-PGA, and 2HOP+L-PGA all increased leaf emergence compared to the untreated group. Treatments containing 2HOP numerically increased emergence versus the untreated by 34% and compared to L-PGA alone, which increased emergence versus the untreated by 19%.

### Example 17

### The Effects of Seed Treatments of L-PGA, 2HOP, and 2HOP+L-PGA on Field Grown Wheat Emergence and Yield.

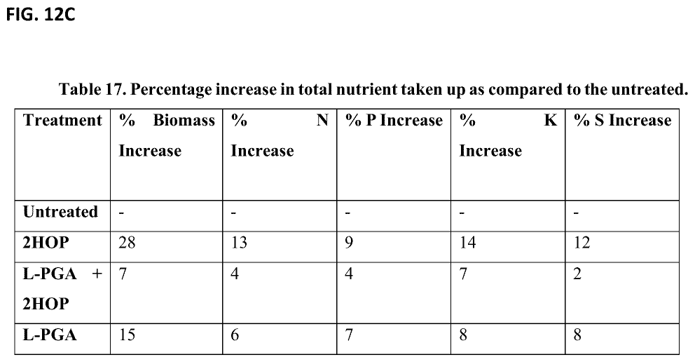

Wheat seeds (Skyfall variety) were treated with 2HOP or 2HOP+L-PGA as shown in Table 19, utilizing a commercial bench top seed treater. The treatments were pre-diluted in an equivalent of 2 liters of water and applied to one ton of seed. The seeds were planted in the fall at a rate of 200 kg/ha. Each treatment had 6 replicates comprising of a 25-meter strip of 6 rows of plants. See Table 20 in FIG. 15.

2HOP, L-PGA, and 2HOP+L-PGA all increased wheat yield statistically compared to the untreated plots. 2HOP+L-PGA resulted in the greatest increase in yield of over 1 ton (see Table 20). This represents an increase of 13.5% compared to the untreated group.

### Example 18

### Effects of Foliar Applications L-PGA, 2HOP, and 2HOP+L-PGA on Field Wheat Yield

A commercial variety of winter wheat (Skyfall variant) was field-grown under standard cultural practices. Wheat seed was sown in the fall of the preceding year at 200 kg seed/ha and harvested the following year in August. Five replicated plots (20 m²) were used for each treatment and compared to the standard farming practice (untreated). The trial was conducted over two crop seasons at the same site. Treatments with L-PGA, 2HOP, or a combination of 2HOP (15%) and L-PGA (85%). Treatments were applied as a single foliar spray at a rate of 100 gm per hectare and applied in 200 Liters of water with a surfactant added (alkyl glucoside at 0.25% v/v). Plants were treated at Zadoks stage 32/35 (Feekes stage 7-7.5).

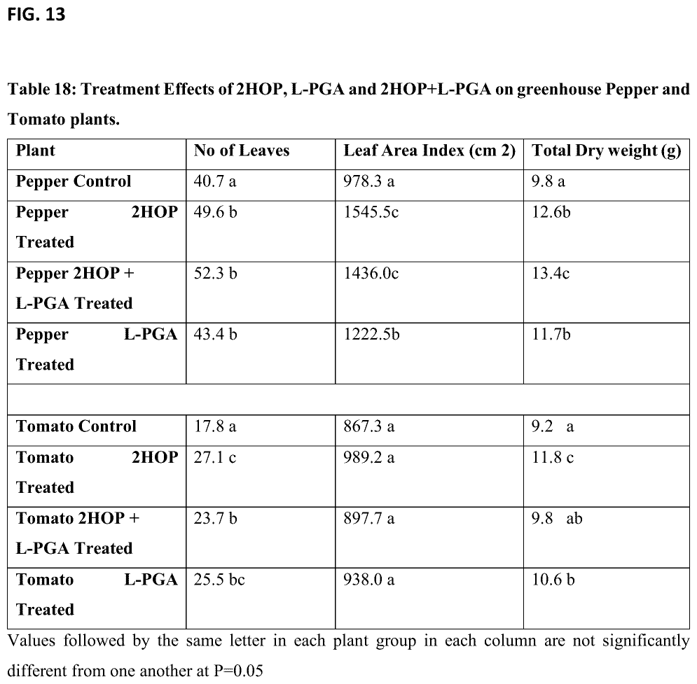

The yield is given in metric tons per hectare. The percentage change in comparison to the untreated (Farmer standard cultural practice) is given. The Duncan Waller statistical test was applied to these data. P values were <0.1 (2018) and <0.05 (2019). In both years the numerical ranking of the treatments was the same (see Table 19). 2HOP+L-PGA was the superior treatment in both crop years. See Table 21 in FIG. 16.

### Example 19

Effects of the Combination of 2-hydroxy-5-oxoproline and Pyroglutamic Acid on Above-Ground Wheat Biomass

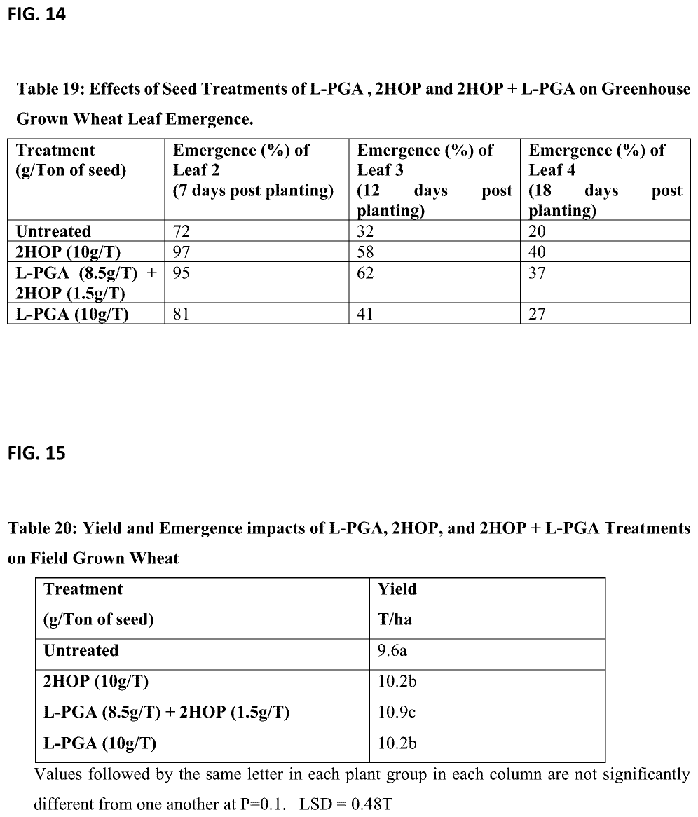

A field trial with winter wheat was used to examine the effect on the dry weight of the biomass produced in treated and untreated plots. The trial used three replicated 20 m² plots of the wheat variety KWS Saki. The 2 HOP (15%)+ and L-PGA (85%) mixture was applied at a rate of 100 g/hectare at the beginning of stem elongation (Zadoks stage 30). The biomass was measured at the beginning of flowering and pollination (Zadoks stage 50). Foliar treatment of wheat plants with the mixture of 2HOP (15%) and L-PGA (85%) resulted in a 6% increase in foliar biomass. See Table 22 in FIG. 17.

### Example 20

Effects of 2-hydroxy-5-oxoproline and L-Pyroglutamate on the Carbon Sequestration Factors, Green Area Index, and Canopy Cover in Field-Grown Wheat.

The amount of biomass produced by a crop relates directly to the amount of CO₂ sequestered by the crop during the growing season. It provides an estimate of the amount of above-ground biomass that is available to be left on the soil surface after harvest that can potentially be incorporated into the soil for longer-term sequestration. The biomass produced during plant development reflects the total amount of biomass that will be produced by those plants under reasonable growing conditions. The green area index is a function of the canopy density and height over the soil area that the plant covers. The canopy cover describes the percentage of the surface of the field covered by the crop canopy. Thus, these two values reflect the biomass that has been produced by the crop in a given field.

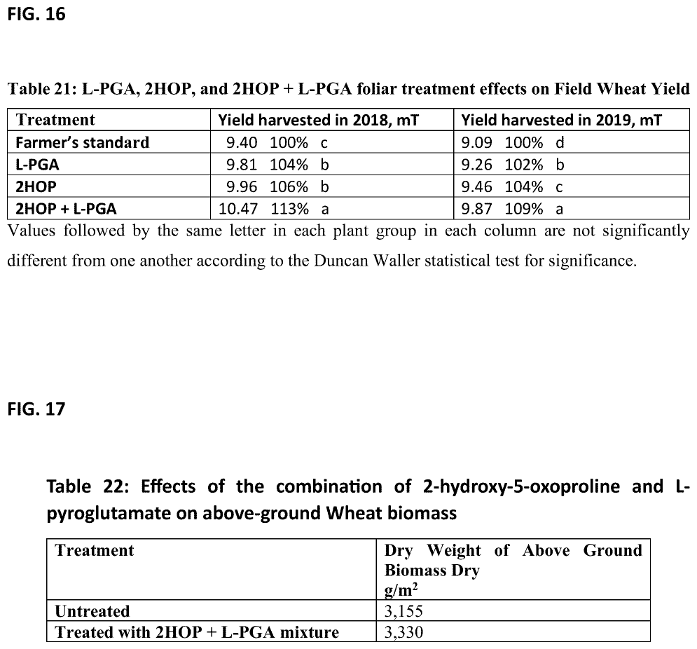

Wheat (variety KWS Saki) was field-grown in five replicated plots (20 m²). In each plot, the area was divided into two areas: one area untreated as the control and one area treated with 2HOP (15%) and L-PGA (85%) applied at the rate of 100 g/Ha. to assess the effect on the green area index and the canopy cover. Plants were treated at Zadoks stage 30/31. See Table 23 in FIG. 18. 2HOP (15%) and L-PGA (85%) foliar application resulted in a 16% increase in GAI and a corresponding 8% increase in crop canopy cover (see Table 21).

### Example 21

Effects of the Combination of 2-hydroxy-5-oxoproline and L-Pyroglutamate on Yield and Average Tuber Weight in Field-Grown Potatoes

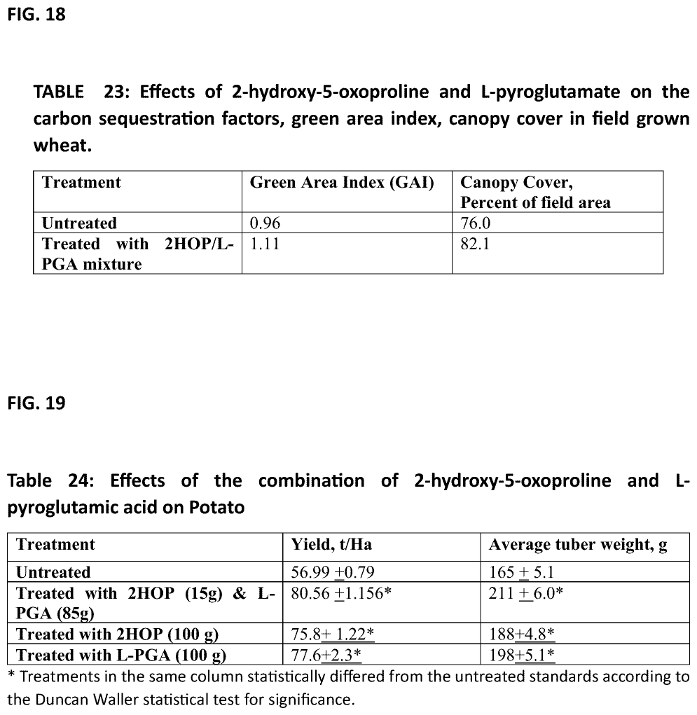

A commercial variety of potatoes (Markies variety) was used to test the various treatments. All plots received the standard farming inputs in terms of cultural practice and chemical inputs. Each plot was eight meters in length along the planting bed. There were three treatments and an untreated standard as shown in Table 22. Each treatment had 4 replicates. All treatments were applied at the rate of 100 g/Ha in 200 liters of water plus 0.025 polyalkyl glucoside as a wetting agent. Plants were assessed in terms of yield and average tuber weight. The yield is given in metric tons per hectare: for yield, P=0.0198. For the average tuber weight, P<0.001. All treatments increased yield and tuber size compared to the controls. 2HOP+L-PGA produced the highest yield increase of 41% and a size increase of 28% as compared to the controls. See Table 24 in FIG. 19.

### Example 22

Effects of 2HOP Combined with L-PGA on Water Stress and Yield to Winter Wheat & Maize

Large plots (2 acres) of Irrigated Wheat and field corn were planted in California (Fresno County) in 2019 and 2020. Wheat (var; Syngenta Blanca Grande 515 Hard White) was planted in December 2019 (125 lbs/acre seed) and field corn (Mycogen) was planted in March 2020 (20 lbs/acre seed). The soil was tested and adjusted to within generally accepted nutritional norms for the growth of these two crops according to UC field corn and winter wheat grower guidelines.

All corn varieties were glyphosate tolerant. Corn plants were grown on 30-inch beds on an average row length of 1,500 feet. Seed was planted approximately two inches deep and six inches apart down the row. The soil was a light sandy loam with 1 percent organic matter in the top 15 inches of soil. The previous crop in the field was corn. Irrigation was by flood. 6-24-6 (derived from Urea, DAP, and potassium sulfate) with ½ percent of zinc was knifed in at planting (additional 20 units N/acre). Weed control was by cultivation and glyphosate herbicide program, and Onager miticide was applied. 200 lbs of nitrogen as UAN 32 was fertigated with and without 1-PGA/2HOP via the irrigation 4 times (April 70 lbs, May 70 lbs, June 30 lbs, and July 30 lbs). The field was harvested on Sep. 30, 2020.

Non-GMO wheat was planted on 60″ raised beds with a grain drill and a preplant 6-24-6 (derived from Urea, DAP, and potassium sulfate) with 12 percent of zinc, knifed in at planting (additional 20 units N/acre). 150 lbs of nitrogen as UAN 32 was fertigated with and without 1-PGA/2HOP via the irrigation 2 times (March 70 lbs, April 80 lbs). Normal integrated pest management practices were employed and 2, 4 D and Bromoxynil were applied in the spring of 2020 for weed control. The crop was harvested in June 2020.

A: The Effect of Two Different Irrigation Regimes (One with Sufficient Water and the Second with Insufficient Water for the Crop) and L-PGA/2HOP Chemigation Treatments on Field Corn Productivity.

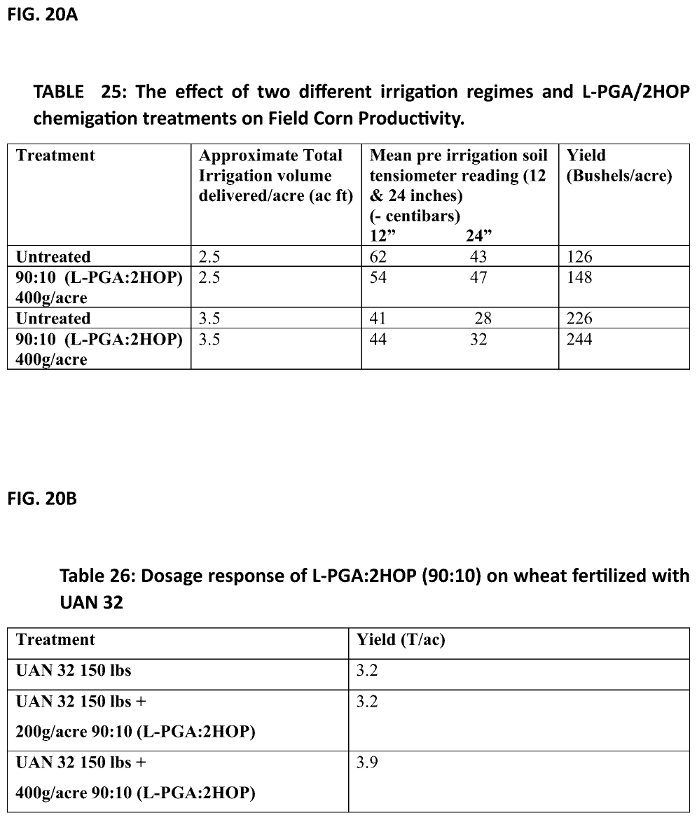

A two (2) acre field was divided into four (4) equal columns. Soil water potential was measured immediately prior to the onset of irrigation by in situ soil tensiometers at 12 and 14 inches below the soil in the planting beds. Three (stations) were in each treatment column. Soil water deliveries were calibrated to deliver 70% of the irrigation volume to two of the columns over the course of the experiment as compared to the other two columns which received a 100% allocation. Natural rain events accounted for approximately 2 inches of precipitation in March and April after which no further rain fell. Irrigation commenced in May (two cycles) and continued through June (4 cycles), July (4 cycles) and August (4 cycles) and ceased on Sep. 1, 2020. Corn requires approximately 3 acre feet of irrigation for optimal productivity which typically requires 3.5 acre feet in terms of delivery volume accounting for system variability. See Table 25 in FIG. 20A. These results show that L-PGA/2HOP (90:10) at 400 g/acre reduced the impact of water stress on plant productivity and in the absence of water stress, increased corn productivity by 8%.

B: Dosage Response of L-PGA:2HOP (90:10) on Wheat Fertilized with UAN 32.

A field was split into three equal columns. All three columns received 150 lbs of UAN 32/acre, split into two applications as described above. Three treatment levels of L-PGA:2HOP (90:10) were applied over the course of two applications with the UAN 32 via fertigation; 0 g/acre, 200 g/acre, and 400 g/acre (total for the crop). See Table 26 in FIG. 20B. These results indicate that fertigation of (L-PGA:2HOP) mixtures with UAN 32 increases Wheat productivity.

1. A composition for increasing plant growth characteristics comprising:
a. 2HOP, a functional derivative of 2HOP; and
b. L-PGA, a functional derivative of L-PGA, or a combination thereof.

2. The composition of claim 1, further comprising a solubilizing agent for improving the solubility of said 2HOP, said functional derivative of 2HOP L-PGA, said functional derivative of L-PGA, or said combination thereof, wherein said solubilizing agent comprises at least one organic acid.

3. (canceled)

4. The composition of claim 2, wherein said at least one organic acid comprises at least one of ethylenediaminetetraacetic acid (EDTA) and hydroxyethylenediaminetriacetic acid (HEDTA).

5. The composition of claim 2, wherein said at least one organic acid comprises an at least one of an amino acid, an unsaturated fatty acid, and a saturated fatty acid, wherein said at least one amino acid comprises at least one of proline, arginine, tryptophan, aspartic acid, glutamic acid, serine, threonine, and cysteine.

6. (canceled)

7. (canceled)

8. (canceled)

9. (canceled)

10. The composition of claim 3, wherein said at least one organic acid comprises at least one of lauric, myristic, stearic, and arachidonic, oleic, linoleic, cinnamic, linolenic, eleostearic, methanoic, ethanoic, propanoic, and butanoic acid.

11. (canceled)

12. (canceled)

13. The composition of claim 3, wherein said at least one organic acid includes at least one of a carboxylic acid having substituted or unsubstituted alkyl, a substituted or unsubstituted cycloalkyl, a substituted or unsubstituted heteroalkyl, a substituted or unsubstituted heterocycloalkyl, a substituted or unsubstituted aryl, and a substituted or unsubstituted heteroaryl moieties.

14. (canceled)

15. (canceled)

16. (canceled)

17. (canceled)

18. (canceled)

19. (canceled)

20. (canceled)

21. (canceled)

22. The composition of claim 1, wherein said composition is a suspension concentrate composition comprising 70 wt % or less of a solid carrier composition.

23. The composition of claim 1, wherein the composition is an aqueous solution, a non-aqueous solution, a suspension, a gel, a foam, a paste, a powder, a dust, a solid, or an emulsion.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The composition of claim 1, further comprising a physiologically active agent comprising at least one of a pesticide, a fungicide, an antibacterial, and a herbicide.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. A method of increasing innate tolerance to abiotic stresses in a plant comprising applying a composition comprising 2HOP, a functional derivative of 2HOP, L-PGA, functional derivative of L-PGA, or a combination thereof to a plant or a growth media therefor.

69. (canceled)

70. (canceled)

71. (canceled)

72. (canceled)

73. (canceled)

74. (canceled)

75. (canceled)

76. The method of claim 68, wherein said composition comprises a solubilizing agent comprising at least one organic acid.

77. The method of claim 76, wherein said at least one organic acid comprises at least one of ethylenediaminetetraacetic acid (EDTA) and hydroxyethylenediaminetriacetic acid (HEDTA).

78. The method of claim 76, wherein said at least one organic acid comprises at least one of an amino acid, an unsaturated fatty acid, and a saturated fatty acid, wherein said at least one amino acid comprises at least one of proline, arginine, tryptophan, aspartic acid, glutamic acid, serine, threonine, and cysteine.

79. (canceled)

80. (canceled)

81. (canceled)

82. (canceled)

83. (canceled)

84. (canceled)

85. (canceled)

86. The method of claim 76, wherein said at least one organic acid includes at least one of a carboxylic acid having substituted or unsubstituted alkyl, a substituted or unsubstituted cycloalkyl, a substituted or unsubstituted heteroalkyl, a substituted or unsubstituted heterocycloalkyl, a substituted or unsubstituted aryl, and a substituted or unsubstituted heteroaryl moieties.

87. (canceled)

88. (canceled)

89. (canceled)

90. (canceled)

91. (canceled)

92. (canceled)

93. (canceled)

94. (canceled)

95. The method of claim 68, wherein said composition is a suspension concentrate composition comprising 70 wt % or less of said solid carrier composition.

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. The method of claim 68, wherein said composition is a granulated composition.

117. (canceled)

118. The method of claim 68, wherein said 2HOP is applied to a field of plants at an application rate in a range of about 10 g of 2HOP per hectare to about 20 g per hectare.

119. A method for increasing innate tolerance to biotic stresses in a plant, comprising:
a. applying to at least one of a plant and a growth medium of said plant an amount of a composition effective to inhibit production of said microbial toxin, said composition comprising at least one of 2HOP, a functional derivative of 2HOP, L-PGA, and functional derivative of L-PGA.

120. The method of claim 119, further comprising applying a bacteriacide, a fungicide, viricide, algicide, or combinations thereof to said plant or said growth media.

121. (canceled)

122. The method of claim 119, wherein said biotic stress is caused by a nematode.

123. The method of claim 119, wherein said biotic stressor is a bacterium.

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. (canceled)

159. (canceled)

160. The method of claim 119, further comprising a physiologically active agent comprising at least one of a pesticide, a fungicide, an antibacterial, a herbicide, or a combination thereof.

161. (canceled)

162. (canceled)

163. (canceled)

164. (canceled)

165. (canceled)

166. (canceled)

167. (canceled)

168. (canceled)

169. The method of claim 119, wherein said 2HOP is applied to a field of plants at an application rate in a range of about 100 g of 2HOP per hectare to about 200 g per hectare.

170-459. (canceled)
